(19) United States
(12) Patent Application Publication
(10) Pub. No.: US 2017/0031674 A1
(43) Pub. Date: Feb. 2, 2017

(54) SOFTWARE INTRODUCTION SUPPORTING METHOD

(71) Applicant: FUJITSU LIMITED, Kawasaki-shi (JP)

(72) Inventor: Tsutomu Hattori, Kakogawa (JP)

(73) Assignee: FUJITSU LIMITED, Kawasaki-shi (JP)

(21) Appl. No.: 15/192,236

(22) Filed: Jun. 24, 2016

(30) Foreign Application Priority Data
Jul. 29, 2015 (JP) 2015-149496

(51) Int. Cl. G06F 9/445; G06F 17/30; H04L 29/08

(52) U.S. Cl. CPC G06F 8/65; H04L 67/10; G06F 17/30321; G06F 8/61; G06F 8/62

(57) ABSTRACT

A software introduction supporting method including: collecting data that indicates operational performance of a plurality of pieces of software operated in a plurality of servers, calculating a continuous operation time for which two or more pieces of software included in the plurality of pieces of software operate in parallel for each server, respectively, based on the collected data, generating an index relating to an influence of introduction of first software to be introduced into one server, based on information that specifies second software introduced into the one server and on the continuous operation time for the two or more pieces of software that includes the first software, when one of the plurality of pieces of software is the first software, and outputting the generated index.

### CROSS-REFERENCE TO RELATED APPLICATION

This application is based upon and claims the benefit of priority of the prior Japanese Patent Application No. 2015-149496, filed on Jul. 29, 2015, the entire contents of which are incorporated herein by reference.

### FIELD

The embodiments discussed herein are related to a software introduction supporting method.

### BACKGROUND

At present, an information processing system that includes a plurality of servers is in use. On each server, various pieces of software are executed. In some cases, a software program is installed on the server while another software program that has been installed is uninstalled. Furthermore, in some cases, a version of the software that has already been installed on the server is updated.

For example, in a proposed technique, when a version of an installed software is upgraded, a predetermined algorithm is used to calculate an influence index, which indicates an influence amount of the version upgrade upon the other pieces of software having already been installed. In this algorithm, information on the number of times or information on the frequency that a function of the software to be upgraded has been used are used.

An example of the related art, Japanese Laid-open Patent Publication No. 2007-265231 is known.

### SUMMARY

According to an aspect of the invention, a software introduction supporting method includes: collecting data that indicates operational performance of a plurality of pieces of software operated in a plurality of servers; calculating a continuous operation time for which two or more pieces of software included in the plurality of pieces of software operate in parallel for each server, respectively, based on the collected data; generating an index relating to an influence of introduction of first software to be introduced into one server, based on information that specifies second software introduced into the one server and on the continuous operation time for the two or more pieces of software that includes the first software, when one of the plurality of pieces of software is the first software; and outputting the generated index.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a software introduction supporting apparatus according to a first embodiment;

FIG. 2 is a diagram illustrating an information processing system according to a second embodiment;

FIG. 3 is a diagram illustrating a hardware example of a collection server;

FIG. 4 is a diagram illustrating a functional example of the information processing system;

FIG. 5 is a diagram illustrating an example of a continuous operation time;

FIG. 6 is a diagram illustrating an example a local management table;

FIG. 7 is a diagram illustrating an example of a master management table;

FIG. 8 is a diagram illustrating an example of an entire server management table;

FIG. 9 is a diagram illustrating an example of an analysis table;

FIG. 10 is a flowchart illustrating an example of registering a management record at the time of installation;

FIG. 11 is a diagram illustrating an example of appending a record for the local management table;

FIG. 12 is a diagram illustrating an example of processing at the time of activation/stopping of software;

FIGS. 13A and 13B are diagrams, each illustrating an example of managing the activation/stopping of the software;

FIG. 14 is a flowchart illustrating an example of updating the continuous operation time and the number of errors;

FIG. 15 is a diagram illustrating a specific example of a record in which each piece of software has been activated;

FIG. 16 is a flowchart illustrating an example of updating the master management table;

FIG. 17 is a diagram illustrating an example of updating the master management table;

FIG. 18 is a flowchart illustrating an example in which a management server collects management information;

FIG. 19 is a flowchart illustrating an example of an analysis at the time of the installation;

FIG. 20 is a flowchart illustrating an example of comprehensive determination;

FIG. 21 is a diagram illustrating an example of calculating a risk level/safety level; and

FIG. 22 is a diagram illustrating an example of a result-of-analysis display screen.

### DESCRIPTION OF EMBODIMENTS

In a case where new software is installed into the server, a malfunction may occur in operation of the software or the other software programs that has already been introduced. As a cause of the malfunction, for example, there is competition among pieces of software for shared resources (a port number, a shared file, and the like). It is considered that in order to avoid the malfunction due to the software introduction, for example, a likelihood that the competition that causes the malfunction will occur is checked in advance for a combination of pieces of software. However, there are a very large number of pieces of software that are check targets, and it is not easy to perform checking in advance for all pieces of software.

An object according to an aspect of an embodiment is to provide a software introduction supporting method of providing support for avoiding a malfunction due to software introduction.

Embodiments will be described below referring to the drawings.

### First Embodiment

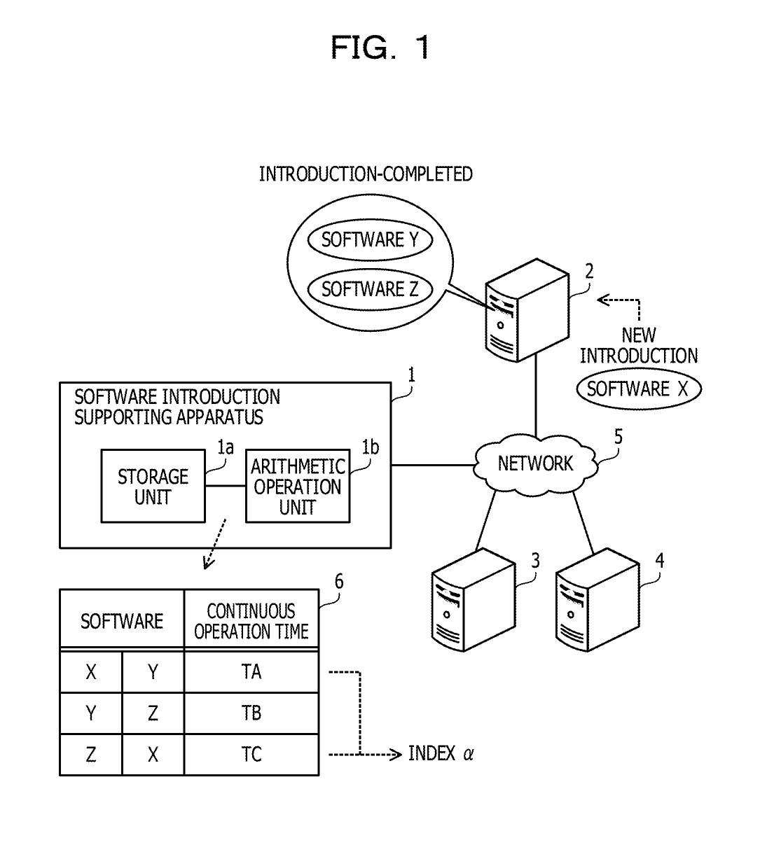

FIG. 1 is a diagram illustrating a software introduction supporting apparatus according to a first embodiment. A software introduction supporting apparatus 1 supports introduction of new software to information processing apparatuses 2, 3, and 4. The software introduction supporting apparatus 1 and information processing apparatuses 2, 3, and 4 are connected to a network 5. Each of the software introduction supporting apparatus 1 and the information processing apparatuses 2, 3, and 4 is referred to as a “computer”.

The software introduction supporting apparatus 1 has a storage unit 1a and an arithmetic operation unit 1b. The storage unit 1a may be a volatile storage device such as a random access memory (RAM), and may be a non-volatile storage device such as a hard disk drive (HDD) or a flash memory. The arithmetic operation unit 1b, for example, is a processor. The processor may be a central processing unit (CPU) or a digital signal processor (DSP). Processors may include integrated circuits such as an application-specific integrated circuit (ASIC) and a field programmable gate array (FPGA). The processor, for example, executes a program that is stored in the RAM. The “processor” may be a set of two or more processors (a multiprocessor).

Stored in the storage unit 1a is information that is used for processing by the arithmetic operation unit 1b. Stored in the storage unit 1a is information that specifies software that has already been introduced into each of the information processing apparatuses 2, 3, and 4. For example, software Y and software Z have already been introduced into the information processing apparatus 2. Software X and the software Y have already been introduced into the information processing apparatus 3. The software Z and the software X have already been introduced into the information processing apparatus 4.

The arithmetic operation unit 1b collects operational performance data of each of the plurality of pieces of software on a plurality of information processing apparatuses and, based on the collected operational performance data, calculates the continuous operation time for which all of two or more pieces of software operate. The continuous operation time is the time for which the plurality of pieces of software operate in parallel. In a case where there are a plurality of periods of time, for each of which the continuous operation is performed in a combination of the same pieces of software in accordance with activation/stopping of the information processing apparatus, the accumulated periods of time may be set as the continuous operation time.

For example, the arithmetic operation unit 1b collects operational performance data of each of the software Y and the software Z from the information processing apparatus 2. The operational performance data includes information that specifies timings of activating and stopping of each of the software Y and the software Z. For example, a period of time from the activating of the software Y to the stopping thereof is a period of time for which the software Y is in activation (this is true for the other pieces of software). Based on operational performance data of the software Y and the software Z, the arithmetic operation unit 1b calculates a continuous operation time TA for which both of the software Y and the software Z operate. Based on the operational performance data of the software Y and the software Z that are collected from the information processing apparatus 3, the arithmetic operation unit 1b calculates a continuous operation time TB. Based on operational performance data of the software Z and the software X that are collected from the information processing apparatus 4, the arithmetic operation unit 1b calculates a continuous operation time TC. The arithmetic operation unit 1b may store a table 6 for managing the calculated continuous operation time in the storage unit 1a.

When any one of the plurality of pieces of software is newly introduced into the information processing apparatus, based on information that is stored in the storage unit 1a, the arithmetic operation unit 1b specifies the software that has already been introduced into the information processing apparatus. Based on a continuous operation time for two or more pieces of information that include the specified software and software to be newly introduced, the arithmetic operation unit 1b outputs an index relating to an influence of the software to be newly introduced into the information processing apparatus into which the software is to be newly introduced.

For example, the arithmetic operation unit 1b receives input to the effect that the software X is to be newly introduced into the information processing apparatus 2. With a user's operational input to an input device that is connected to the software introduction supporting apparatus 1, the arithmetic operation unit 1b may receive input for the introduction of the software X into the information processing apparatus 2. Alternatively, the arithmetic operation unit 1b may receive the input for the introduction of the software X into the information processing apparatus 2 from the information processing apparatus 2 through a network 5.

The arithmetic operation unit 1b specifies that the software Y and the software Z have already been introduced into the information processing apparatus 2. As described above, based on the information that is stored in the storage unit 1a, the arithmetic operation unit 1b can specify the software Y and the software Z that have already been introduced into the information processing apparatus 2. Furthermore, based on the table 6, the arithmetic operation unit 1b acquires information relating to the introduction-target software Y and the software Z that have been introduced. Specifically, the arithmetic operation unit 1b acquires the continuous operation time TA that corresponds to the software X and the software Y. Additionally, based on the table 6, the arithmetic operation unit 1b acquires the continuous operation time TC that corresponds to the software Z and the software X.

For example, based on the continuous operation time TA that corresponds to the software X and the software Y, the arithmetic operation unit 1b can evaluate a likelihood that in a case where both of the software X and the software Y are introduced, a malfunction will occur. More specifically, if the continuous operation time TA is equal to or greater than a predetermined time, an evaluation can be made that in the software X and the software Y, a risk that competition for shared resources will occur is comparatively low and a likelihood that the malfunction will occur is low. Generally, this is because there is a tendency for a lot of malfunctions to occur in an initial state of the software introduction, and because if a fixed time elapses after the introduction, there is a tendency for the software to operate stably.

On the other hand, the evaluation is made that if the continuous operation time TA is shorter than the predetermined time, an evaluation can be made that in the software X and the software Y, there is a desire to exercise caution about the risk that the competition for the shared resources will occur. This is because in a case where a continuous operation time for the software X and the software Y is comparatively short, there is a likelihood that any one of the software X and the software Y will stop its operation due to the competition for the shared resources while both of the software X and the software Y are in operation. In this case, based on the number of errors during a period of time for which both of the software X and the software Y operate, the arithmetic operation unit 1b may evaluate a likelihood that the malfunction will occur. For example, if the error occurrence frequency during a fixed period of time is equal to or greater than a predetermined frequency, an evaluation may be made that in the software X and the software Y, the risk that the competition for the shared resources will occur is comparatively high and the likelihood that the malfunction will occur is high. Furthermore, the evaluation may be made that if the error occurrence frequency during the fixed period of time is smaller than the predetermined frequency, there is a desire to exercise caution about the likelihood that the malfunction will occur. Moreover, in order to perform an evaluation of the number of errors, based on the operational performance data of each piece of software, the arithmetic operation unit 1b may acquire the number of errors in each of the two or more pieces of software during a period of time for which the two or more pieces of software are in operation, along with a continuous operation time.

In the same manner, based on the continuous operation time TC that corresponds to the software Z and the software X, the arithmetic operation unit 1b can evaluate a situation in which the malfunction occurs in a case where both of the software Z and the software X are introduced. In this way, the arithmetic operation unit 1b evaluates a likelihood that the malfunction will occur in each of the software Y and the software Z in a case where the new software X is introduced into the information processing apparatus 2. For example, the arithmetic operation unit 1b may individually output a result of performing an evaluation on each of a set of the software X and the software Y and a set of the software X and the software Z, as an index α relating to an influence of the introduction of the software X. When this is done, the specification by the user of the software that causes the malfunction can be supported.

Alternatively, the arithmetic operation unit 1b may create a comprehensive result of determination from a result of an evaluation of each of the software Y and the software Z, and may output the comprehensive result of the determination as the index α relating to the influence of the introduction of the software X. For example, for the information processing apparatus 2, the arithmetic operation unit 1b obtains a result of an evaluation of the influence of the introduction of the software X on the software Y, and a result of an evaluation of the influence of the introduction of the software X on the software Z. Specifically, in a case where at least any one of the results of both of the evaluations is that the likelihood that the malfunction will occur is comparatively high, the arithmetic operation unit 1b may make an evaluation that the likelihood that the malfunction will occur is high in a case where the software X is introduced into the information processing apparatus 2, and may set the result of the evaluation as the index α. On the one hand, in a case where the results of both of the evaluations are that the likelihood that the malfunction will occur is comparatively low, the arithmetic operation unit 1b may make an evaluation that the likelihood that the malfunction will occur is low in the case where the software X is introduced into the information processing apparatus 2, and may set the result of the evaluation as the index α.

The arithmetic operation unit 1b may output the index α to a display device such as a display that is connected to the software introduction supporting apparatus 1, and may display details of the index α on the display device. The details of the index α may be displayed with a numerical value, a symbol, or a string of letters that indicates the likelihood that the malfunction will occur. Furthermore, the arithmetic operation unit 1b may output the index α to a different information processing apparatus such as the information processing apparatus 2, through the network 5. For example, in this case, the different information processing apparatus that receives the index α can output the index α to a display device, which is connected to the different information processing apparatus, for display. For example, the user can check the display of the index α and thus can know the likelihood that the malfunction will occur in the case where the software X is introduced into the information processing apparatus 2. Depending on a result of the checking, the user can determine whether or not the software X is introduced into the information processing apparatus 2.

In the example described above, the case where the continuous operation time for the two pieces of software is obtained from the period of time for which the two piece of software are in activation is mainly described, but the arithmetic operation unit 1b may obtain a continuous operation time for three or more pieces of software from a period of time for which three or more pieces of software are in activation. Based on the continuous operation time for the three or more pieces of software, the arithmetic operation unit 1b may evaluate the index α. For example, it is also considered that a sum of the periods of time for which the three pieces of software are in activation is obtained as the continuous operation time and that the index α is evaluated according to whether or not the continuous operation time is longer than a predetermined time.

In this way, the software introduction supporting apparatus 1 can provide the support for avoiding the malfunction due to the introduction of the software. For example, in order to avoid the malfunction due to the introduction of the software, it is also considered that competition of all pieces of software, which have a likelihood of being introduced, with different pieces of software for the shared resources, and the like, are examined in advance. However, there are a very large number of pieces of software that are check targets and there are also a variety of writing sources of the software. Thus, this checking is not easy to perform in advance.

On the other hand, in the software introduction supporting apparatus 1, because with the performances of the pieces of software that are accumulated while the information processing apparatuses 2, 3, and 4 are in operation, an index relating to the influence of the introduction of the software is evaluated, the evaluation is made more efficiently than when the checking is performed in advance. For example, various pieces of software can be introduced into each information processing apparatus and can be used. Because performances of pieces of software in a plurality of information processing apparatuses serve as a base, the software introduction supporting apparatus 1 can easily improve the comprehensiveness (coverage) of a combination of software and software that can be evaluation targets. Furthermore, the saving of a user's labor can be achieved much more than when the user has to perform the checking in advance.

Moreover, it is also considered that the arithmetic operation unit 1b acquires operational performance data of a combination of the same pieces of software from two or more information processing apparatuses and obtains a performance for a continuous operation time in the two or more information processing apparatuses. In that case, the arithmetic operation unit 1b stores the acquired performance for the continuous operation time in the storage unit 1a, in a state of being associated with a combination of pieces of software and with identification information of every information processing apparatus. Then, the arithmetic operation unit 1b may evaluate the stability that results when the operation is performed in a combination of the pieces of software according to the continuous operation that is calculated for every information processing apparatus, for every information processing apparatus. For example, the arithmetic operation unit 1b may determine the index α using the number of the information processing apparatuses that are evaluated as operating stably and the number of the information processing apparatuses that are evaluated as not operating stably.

More specifically, when a focus is put on the introduction-target software X and the software Y that has been introduced, if a ratio of the number of the information processing apparatuses being evaluated as operating stably to the total number of the information processing apparatuses for which the software X and the software Y are the evaluation targets is comparatively high, the arithmetic operation unit 1b evaluates the likelihood of the malfunction occurring at the time of the introduction of the software X, as being comparatively low. On the one hand, if a ratio of the number of the information processing apparatuses being evaluated as not operating stably to the total number of the information processing apparatuses for which the software X and the software Y are the evaluation targets is comparatively high, the arithmetic operation unit 1b evaluates the likelihood of the malfunction occurring at the time of the introduction of the software X, as being comparatively high. In this way, with the operational performance data of the pieces of software that are collected from the plurality of information processing apparatuses, the arithmetic operation unit 1b can improve the precision of the evaluation of the likelihood that the malfunction will occur.

### Second Embodiment

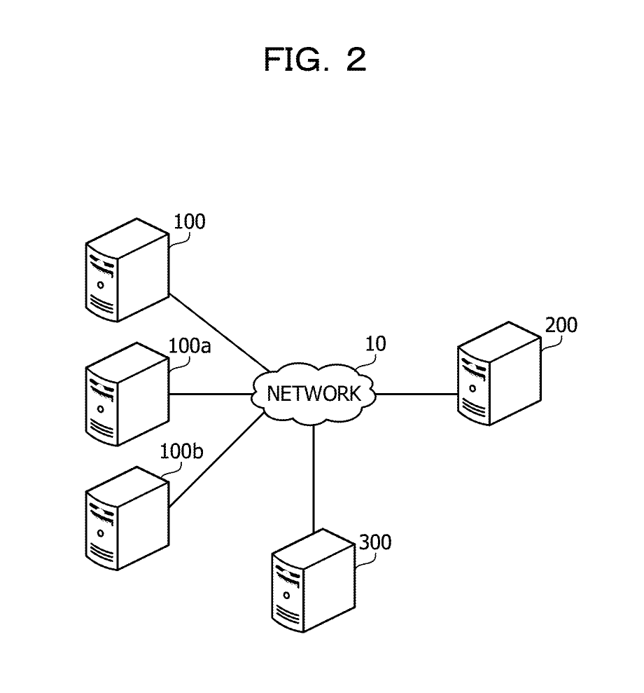

FIG. 2 is a diagram illustrating an information processing system according to a second embodiment. The information processing system according to the second embodiment includes collection servers 100, 100a, and 100b, a management server 200, and an analysis server 300. The collection servers 100, 100a, and 100b, the management server 200, and the analysis server 300 are connected to a network 10. The network 10, for example, is a local area network (LAN).

The collection servers 100, 100a, and 100b are server computers that are used for user's business. The collection servers 100, 100a, and 100b execute various pieces of software that support the user's business. For example, the collection servers 100, 100a, and 100b may receive a request for business processing through a network 10 from a client apparatus (whose illustration is omitted) that is used by the user. In that case, the collection servers 100, 100a, and 100b perform the business processing according to the request, and replies to the client apparatus with a result of the business. The collection servers 100, 100a, and 100b acquires information on operational performances of pieces of software in the collection servers 100, 100a, and 100b themselves, respectively, and transmit the acquired information to the management server 200.

The management server 200 is a server computer that manages information that is used in a unified manner for processing by the collection servers 100, 100a, and 100b and the analysis server 300. For example, the management server 200 acquires information that is generated by the collection servers 100, 100a, and 100b and stores the acquired information in a state of being associated with identification information of each collection server. In some cases, the management server 200 also provides the stored information to the analysis server 300.

The analysis server 300 is the server computer for the user's business (which, at this point, can be used for the user's business in the same manner as the collection servers 100, 100a, and 100b). When new software is introduced into the analysis server 300, the analysis server 300 evaluates a likelihood that introduction of the new software will cause the malfunction in operation of different software that has been introduced into the analysis server 300. Moreover, like the collection servers 100, 100a, 100b, the analysis server 300 may acquire information on operational performance of software in the analysis server 300 itself, and may transmit the acquired information to the management server 200.

At this point, various pieces of software are newly introduced into the collection servers 100, 100a, and 100b and the analysis server 300 according to details of the business, or are deleted therefrom. In some cases, the new introduction of certain software into a certain information processing apparatus (a computer) is referred to as installation. Furthermore, in some cases, the deletion of the software installed in a certain information processing apparatus from the certain information processing apparatus is referred to as uninstallation.

For example, in the installation, various pieces of data (which, for example, includes an execution program and a configuration information) for executing software are stored in a non-volatile storage device, such as an HDD, which is included in the information processing apparatus that is an installation destination. In the uninstallation, in some cases, an operational configuration of software is also written into information that is managed by an operating system (OS) of the information processing apparatus that is the installation destination. Furthermore, for example, in the uninstallation, the various pieces of data that are stored at the time of the installation are deleted, or the operational configuration of the software that is written into the information which is managed by the OS is deleted.

At the time of the installation of the software, as described above, the information for executing the software is written into the information processing apparatus that is the installation destination. At this time, the operation of the software is interrupted when competition for the use of the shared resources (for example, a port number of a transmission control protocol (TCP)/a user datagram protocol (UDP), a shared file, or the like) available in the information processing apparatus occurs between pieces of software. For example, problems can occur such as one in which the same port number is used in a plurality of pieces of software and thus communication with a different information processing apparatus is not performed and one in which details of the configuration of the shared file are updated by the plurality of pieces of software and thus each piece of software is not executed with a suitable configuration. Accordingly, in the information processing system according to the second embodiment, at the time of the introduction of software, a function of providing the support for avoiding this malfunction relating to the operation of the software is provided.

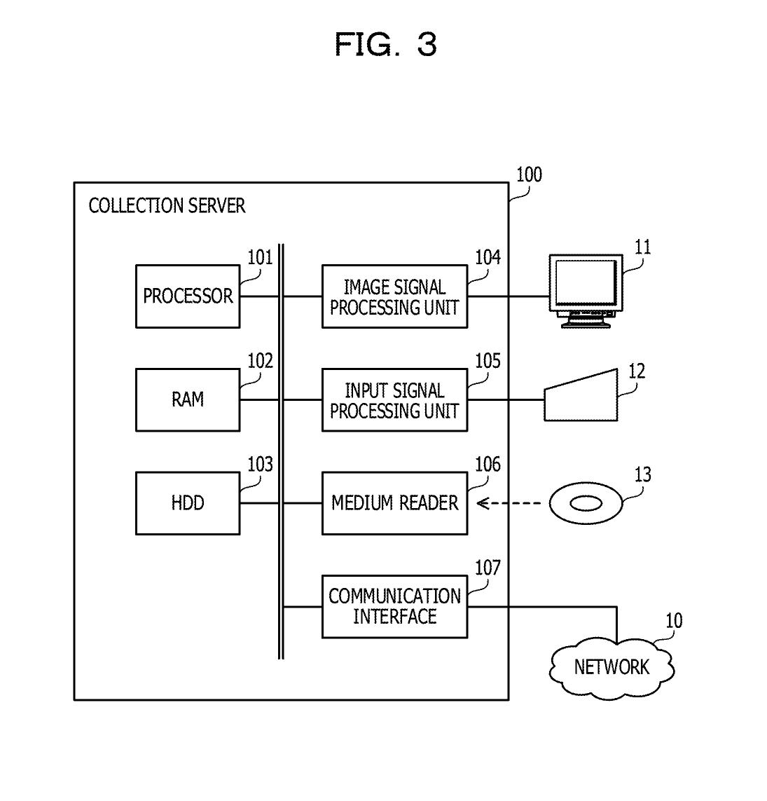

FIG. 3 is a diagram illustrating a hardware example of the collection server. The collection server 100 has a processor 101, a RAM 102, an HDD 103, an image signal processing unit 104, an input signal processing unit 105, a medium reader 106, and a communication interface 107. Each unit is connected to a bus of the collection server 100. The collection servers 100a and 100b, the management server 200, and the analysis server 300 can also be realized using the same hardware as in the collection server 100.

The processor 101 controls information processing by the collection server 100. The processor 101 may be a multiprocessor. The processor 101 is, for example, a CPU, a DSP, an ASIC, an FPGA, or the like. The processor 101 may be a combination of two or more of the CPU, the DSP, the ASIC, the FPGA, and the like.

The RAM 102 is a main storage device of the collection server 100. Temporarily stored in the RAM 102 are at least one or both of an OS program and an application program that are executed by the processor 101. Furthermore, various pieces of data are stored in the RAM 102, using processing by the processor 101.

The HDD 103 is an auxiliary storage device of the collection server 100. Data is magnetically read from and written to magnetic disks that are built into the HDD 103. The OS program, the application program, and various pieces of data are stored in the HDD 103. The collection server 100 may include a different type of auxiliary storage device, such as a flash memory or a solid state drive (SSD), and may include a plurality of auxiliary storage devices.

In accordance with a command from the processor 101, the image signal processing unit 104 outputs an image to a display 11 that is connected to the collection server 100. As the display 11, a cathode ray tube (CRT) display, a liquid crystal display, or the like can be used.

The input signal processing unit 105 acquires an input signal from the input device 12 that is connected to the collection server 100, and outputs the acquired input signal to the processor 101. As the input device 12, for example, a pointing device, such as a mouse or a touch panel, a keyboard, or the like can be used.

The medium reader 106 is a device that reads a program or data that is recorded in a recording medium 13. As the recording medium 13, for example, a magnetic disk, such as a flexible disk (FD) or an HDD, an optical disc, such as a compact disc (CD), or a digital versatile disc (DVD), and a magneto-optical (MO) disk can be used. Furthermore, as the recording medium 13, for example, a non-volatile semiconductor memory can be used such as a flash memory card. In accordance with the command from the processor 101, the medium reader 106, for example, stores a program or data that is read from the recording medium 13 in the RAM 102 or the HDD 103.

The communication interface 107 communicates with a different apparatus through the network 10. The communication interface 107 may be a wired communication interface, and may be a wireless communication interface.

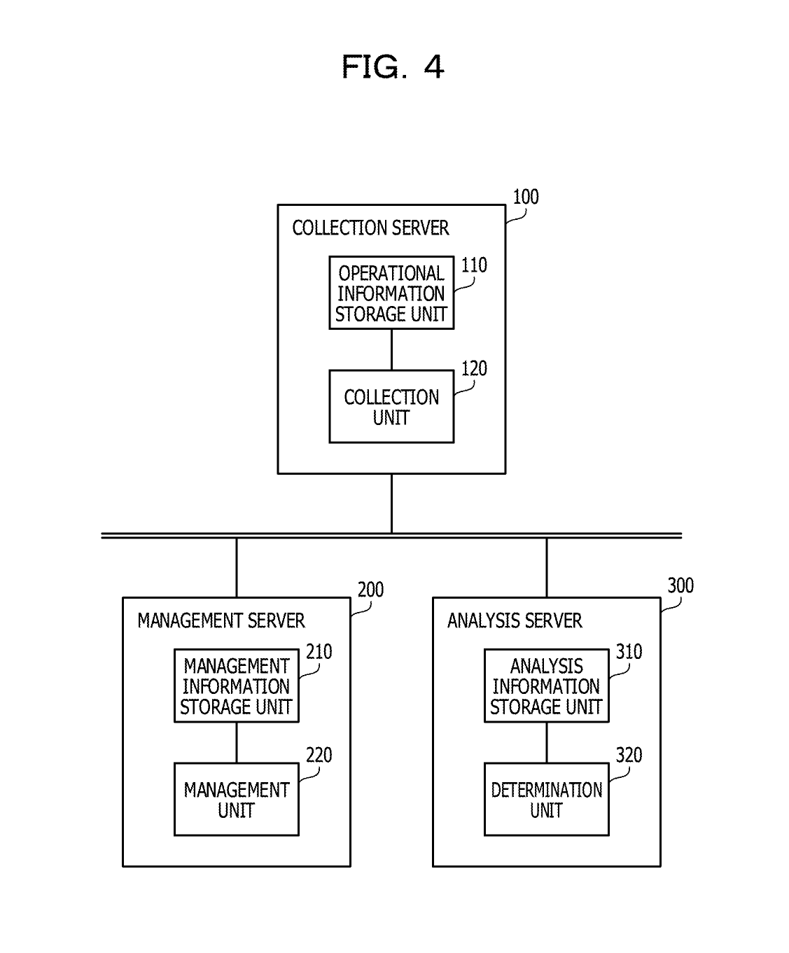

FIG. 4 is a diagram illustrating a functional example of the information processing system. The collection server 100 has an operational information storage unit 110 and a collection unit 120. The operational information storage unit 110 can be realized using a storage area that is secured in the RAM 102 or the HDD 103. The processor 101 executes a program that is stored in the RAM 102, and thus the collection unit 120 can be realized. Moreover, the collection servers 100a and 100b has the same function as the collection server 100. Illustrations of the collection servers 100a and 100b are omitted in FIG. 4.

The operational information is stored in the operational information storage unit 110. The operational information is information relating to operational performance of a set of two pieces of software that are installed in the collection server 100. Pieces of software of which pieces of operational information are acquisition targets can include an OS, middle ware, application software for supporting the user's business, and the like.

The collection unit 120 monitors the activation or the stopping of the software that is installed on the collection server 100, acquires operational performance data of the software, and stores the acquired operational performance data in the operational information storage unit 110. Specifically, for certain two pieces of software, the collection unit 120 acquires a period of time for which both of the pieces of software operate continuously. The collection unit 120 calculates a continuous operation time for which both of the pieces of software operate by integrating the periods of time, and stores the calculated continuous operation time in the operational information storage unit 110. Furthermore, the collection unit 120 acquires the number of errors relating to both of the pieces of software occurs during the period of time for which both of the pieces of software operate, and stores the acquired number of errors in the operational information storage unit 110. For example, based on a log (which includes identification information on the software) that is output by the OS on the collection server 100 or a log that is output by each piece of software, the collection unit 120 can acquire the number of errors in any of the pieces of software.

Furthermore, the collection unit 120 transmits the operational information that is stored in the operational information storage unit 110 to the management server 200 with a predetermined periodicity (for example, one time per one to several hours, one time per day, or the like). The management server 200 has a management information storage unit 210 and a management unit 220. The management information storage unit 210 can be realized using a storage area that is secured in the storage device, such as the RAM or the HDD, which is included in the management server 200. The processor that is included in the management server 200 executes a program that is stored in the storage device which is included in the management server 200, and thus the management unit 220 can be realized.

Management information is stored in the management information storage unit 210. The management information is information for managing in a unified manner pieces of operational information that are acquired from the collection servers 100, 100a, and 100b. The management unit 220 acquires the pieces of operational information from the collection servers 100, 100a, and 100b with a predetermined periodicity, and stores the acquired pieces of operational information in the management information storage unit 210 in a state of being associated with identification information of the collection server that is an acquisition source. Pieces of operational information relating to all the servers that are the acquisition sources are integrated into one piece of information that is referred to as the management information. At the request of the analysis server 300, the management unit 220 provides one piece of information that constitutes the management information, to the analysis server 300.

The analysis server 300 has an analysis information storage unit 310 and a determination unit 320. The analysis information storage unit 310 can be realized using the storage area that is secured in the storage device, such as the RAM or the HDD, which is included in the analysis server 300. The processor that is included in the analysis server 300 executes a program that is stored in the storage device which is included in the analysis server 300, and thus the determination unit 320 can be realized.

Analysis information is stored in the analysis information storage unit 310. The analysis information is information that is used for the analysis server 300 to determine the likelihood that the malfunction will occur at the time of the installation of the software. Furthermore, information (information that is a source of the analysis information) that is acquired from the management server 200 is also stored in the analysis information storage unit 310.

When certain software is installed on the analysis server 300, based on information on the software that has already been installed on the analysis server 300 and information that is acquired from the management server 200, the determination unit 320 determines the likelihood that the malfunction will occur due to the installation. The determination unit 320 outputs a result of the determination to a display device, such as a display, which is connected to the analysis server 300, for display.

At this point, in an example in FIG. 4, functions of the collection server 100 and the analysis server 300 are illustrated as being separated from each other. However, the collection server 100 may also have a function (which is equivalent to the analysis information storage unit 310 and the determination unit 320) of the analysis server 300, which result from combining the operational information storage unit 110 and the collection unit 120 (this is also true for the collection servers 100a and 100b). Furthermore, the analysis server 300 may also have a function (which is equivalent to the operational information storage unit 110 and the collection unit 120) of the collection server 100, which results from combining the analysis information storage unit 310 and the determination unit 320.

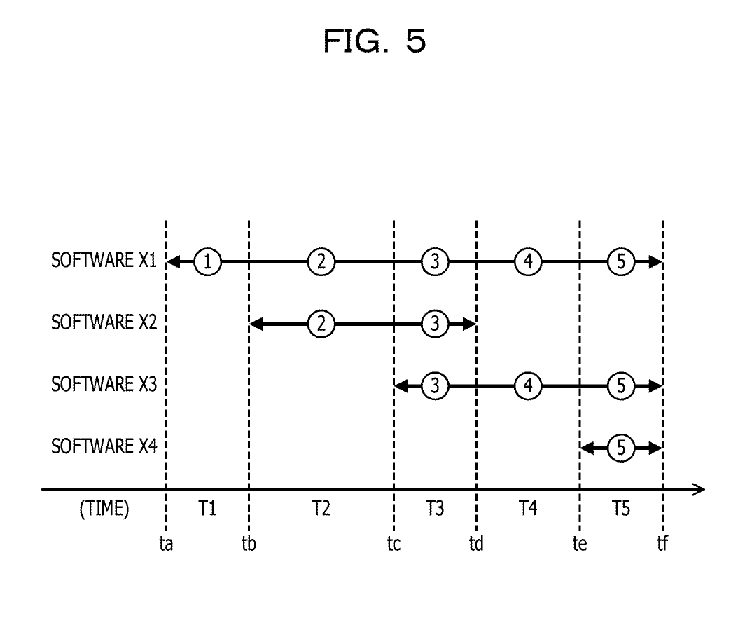

FIG. 5 is a diagram illustrating an example of the continuous operation time. The continuous operation time indicates a time for which each piece of software operates during a time section between a point in time of installation and a point in time of uninstallation, with the point in time of installation and the point in time of the uninstallation serving as a boundary.

For example, a case is considered in which software X1, software X2, software X3, and software X4 are installed and uninstalled in the collection server 100. Software that is installed is activated and operates in the collection server 100. A point in time ta is a point in time at which the software X1 is installed. A point in time tb is a point in time that comes later than the point in time ta, and is a point in time at which the software X2 is installed. A point in time tc is a point in time that comes later than the point in time tb, and is a point in time at which the software X3 is installed. A point in time td is a point in time that comes later than the point in time tc, and is a point in time at which the software X2 is uninstalled. A point in time te is a point in time that comes later than the point in time td, and a point in time at which the software X4 is installed. A point in time tf is a point in time that comes later than the point in time te, and is a reference point in time (for example, a current point in time) at which to estimate the continuous operation time.

A time difference between the points in time ta and tb is time T1. A time difference between the points in time tb and tc is time T2. A time difference between the points in time tc and td is time T3. A time difference between the points in time td and te is time T4. A time difference between the points in time te and tf is time T5.

In this case, a continuous operation time for the software X1 is the times T1+T2+T3+T4+T5. In this case, the continuous operation time for the software X2 is the times T2+T3. In this case, the continuous operation time for the software X3 is the times T3+T4+T5. In this case, the continuous operation time for the software X4 is the time T5.

Additionally, a continuous operation time for a set of the software X1 and the software X2 (that is, a time for which both of the software X1 and the software X2 operate) is the times T2+T3. A continuous operation time for a set of the software X1 and the software X3 is the times T3+T4+T5. A continuous operation time for a set of the software X1 and the software X4 is the time T5. A continuous operation time for a set of the software X2 and the software X3 is the time T3. A continuous operation time for a set of the software X3 and the software X4 is the time T5.

Moreover, in an example in FIG. 5, in some cases, the collection server 100 is also shut down and is powered off. In a case where there is a period of time for which the collection server 100 is in a power-off state, the continuous operation time from which the time corresponding to the period of time is excluded is obtained (if the collection server 100 return to a power-on state, each software is activated and operates). That is, in a case where there are a plurality of periods of time, for each of which the continuous operation is performed in a combination of the same pieces of software in accordance with activation/stopping of the collection server 100, the accumulated periods of time may be set as the continuous operation time. Alternatively, among the plurality of period of time, the longest period of time may be set to be the continuous operation time for the set of the pieces of software in the collection server 100.

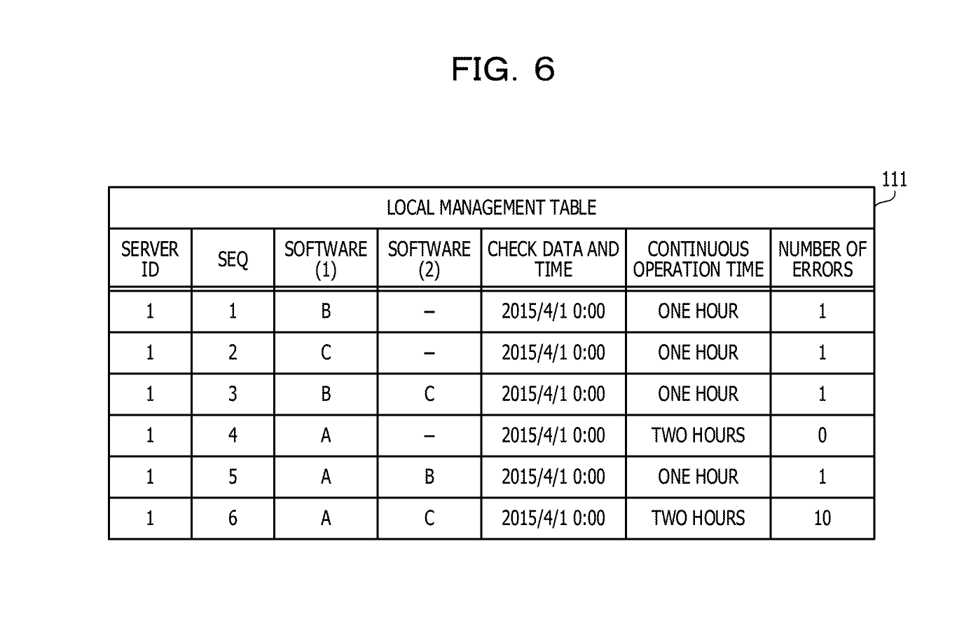

FIG. 6 is a diagram illustrating an example of a local management table. A local management table 111 is stored in the operational information storage unit 110. The local management table 111 is used for acquisition of the operational information by the collection unit 120. The collection servers 100a and 100b and the analysis server 300 also retain the same information as the local management table 111. The local management table 111 includes the following headings: a server identifier (ID), a sequence (SEQ), software (1), software (2), check date and time, a continuous operation time, and the number of errors.

Server ID is registered under the heading of the server ID. The server ID is identification information of each server. Because the local management table 111 is created by the collection server 100, a server ID of the collection server 100 is registered under the heading of the server ID. The server ID of the collection server 100 is set to “1”. A number that is given to a record is registered under the heading of the SEQ. For example, a number is given to each record in ascending order, and the number given is registered under the heading of the SEQ. Identification information on first software is registered under the heading of the software (1). Identification information on second software is registered under the heading of the software (2). In some cases, software identification information is also not registered under the heading of the software (2). A point in time (check date and time) at which the continuous operation time is last checked is registered under the heading of the check date and time. The number of times that an error relating to the first software or the second software occurs during a period of time between the check date and time that is registered under the heading of the check date and time and the immediately-preceding check date and time is registered under the heading of the number of errors.

For example, in the local management table 111, as pieces of information, “1”, “1”, “B”, “2015/4/1 0:00”, “one hour”, and “1” are registered under the headings of the server ID, the SEQ, the software (1), the check date and time, the continuous operation time, and the number of errors, respectively, and non-setting is provided for registration under the heading of the software (2) (non-setting is illustrated with the symbol hyphen “-”).

This is a record for the SEQ “1” in the collection server 100 that corresponds to the server ID “1” and indicates the operational information for the software B alone. Furthermore, the point in time at which the continuous operation time is last checked is 0 hour, 00 minute, Apr. 1, 2015, and the continuous operation time for the software B alone is “one hour”. Additionally, it is indicated that the number of times that an error relating to the software B occurs between the point in time and the check date and time that precedes immediately the check date and time is 1.

Furthermore, for example, in the local management table 111, as pieces of information, “1”, “3”, “B”, “C”, “2015/4/1 0:00”, “one hour”, and “1” are registered under the headings of the server ID, the SEQ, the software (1), the software (2), the check date and time, the continuous operation time, and the number of errors, respectively.

In the same manner as in the record for the SEQ “1,” this is a record for the SEQ “3” in the collection server 100 that corresponds to the server ID “1” and indicates the operational information relating to a set of for the software B and the software C. Furthermore, the point in time at which the continuous operation time is last checked is 0 hour, 00 minute, Apr. 1, 2015, and the continuous operation time for which both of the software B and the software C operate is “one hour”. Additionally, it is indicated that the number of times that an error relating to the software B or the software C occurs between the point in time and the check date and time that precedes immediately the pint in time is 1. Operational information relating to different software is also registered in the same manner in the local management table 111.

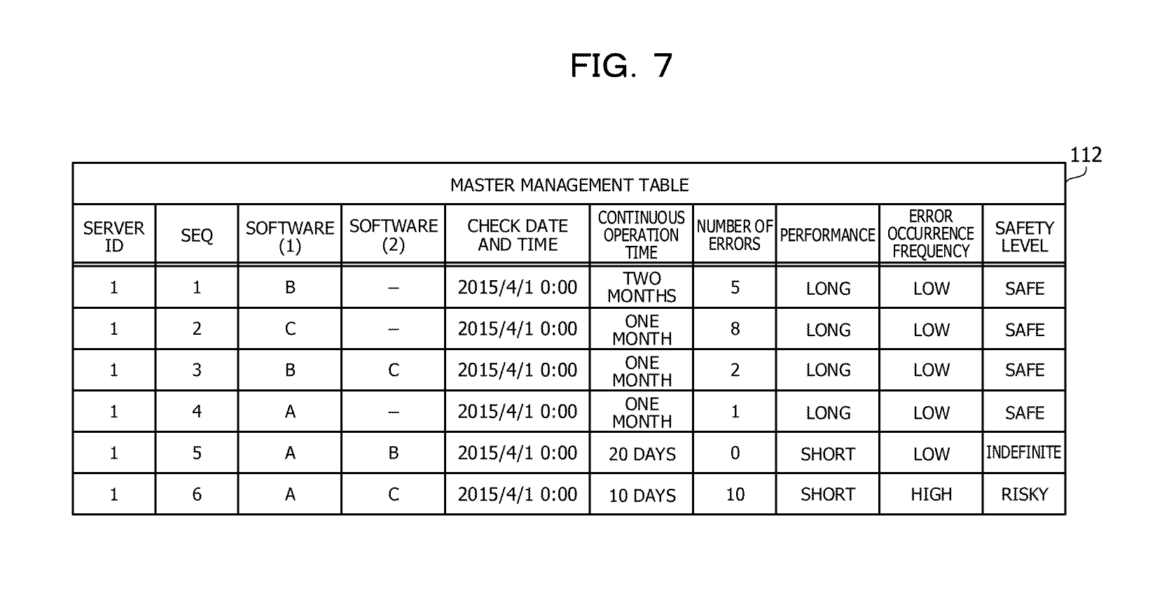

FIG. 7 is a diagram illustrating an example of a master management table. A master management table 112 is stored in the operational information storage unit 110. The collection servers 100a and 100b and the analysis server 300 also retain the same information as the local management table 111. The master management table 112 includes the following headings: the server ID, the SEQ, the software (1), the software (2), the check date and time, the continuous operation time, the number of errors, a performance, error occurrence frequency, and a safety level.

At this point, contents that are registered under the headings of the server ID, the SEQ, the software (1), the software (2), the check date and time, the continuous operation time and the number of errors are the same as those registered under the same headings for the local management table 111. However, an accumulation value is registered under the heading of the continuous operation time and the number of errors for the master management table 112. In formation indicating whether or not the continuous operation time is longer than a reference time (a performance threshold) is registered under the heading of the performance. Information indicating whether or not the error occurrence frequency during a fixed period of time, which is calculated based on the number of errors is greater than reference frequency (an error frequency threshold) is registered under the heading of the error occurrence frequency. Information indicating a result of revaluation of the safety level, which is determined based on the performance and the error occurrence frequency, is registered under the heading of the safety level. The safety level is an index indicating the degree to which an error occurs in a case where the software (or a set of pieces of software) is caused to operate. In an example according to the second embodiment, there are three types of categories: “safe”, “risky”, and “indefinite”. The term “safe” indicates that an operation is evaluated as performing stably (that is, that the degree to which a malfunction occurs is comparatively low). The term “risky” indicates that the operation is evaluated as not performing stably (that is, that the degree to which the malfunction occurs is comparatively high). The term “indefinite” indicates that a “safe” or “risky” categorization is not possible.

For example, in the master management table 112, as pieces of information, “1”, “1”, “B”, “2015/4/1 0:00”, “two months”, “5”, “long”, “small”, and “safe” are registered under the headings of the server ID, the SEQ, the software (1), the check date and time, the continuous operation time, the number of errors, the performance, the error occurrence frequency, and the safety level, respectively, and non-setting is provided for registration under the heading of the software (2).

This indicates that the continuous operation time for which the software B operates in the collection server 100 is two months and that the number of errors in the software B during the period of time of two months is 5. Furthermore, it is indicated that the continuous operation time of two months, as the performance for the continuous operation time, is longer than the performance threshold. Additionally, it is indicated that the number of errors during the period of time of two months, that is, 5, as the error occurrence frequency, is smaller than the error frequency threshold. Then, it is indicated that the safety level in a case where the software B operates in the collection server 100 is evaluated as being “safe”.

Furthermore, for example, in the master management table 112, as pieces of information, “1”, “3”, “B”, “C” “2015/4/1 0:00” “one month”, “2”, “long”, “low”, and “safe” are registered under the headings of the server ID, the SEQ, the software (1), the software (2), the check date and time, the continuous operation time, the number of errors, the performance, the error occurrence frequency, and the safety level, respectively.

This indicates that the continuous operation time for which both of the software B and the software C operate in the collection server 100 is one month and that the number of errors in the software B and the software C during the period of time of one month is 2. Furthermore, it is indicated that the continuous operation time, that is, one month, as the performance for the continuous operation time, is longer than the performance threshold. Additionally, it is indicated that the number of errors during the period of time of one month, that is, 2, as the error occurrence frequency, is smaller than the error frequency threshold. Then, it is indicated that the safety level in a case where both of the software B and the software C operate in the collection server 100 is evaluated as being “safe”.

Furthermore, for example, in the master management table 112, as pieces of information, “1”, “6”, “A”, “C”, “2015/4/1 0:00”, “ten days”, “10”, “short”, “high”, and “risky” are registered under the headings of the server ID, the SEQ, the software (1), the software (2), the check date and time, the continuous operation time, the number of errors, the performance, the error occurrence frequency, and the safety level, respectively.

This indicates that the continuous operation time for which both of the software A and the software C operate in the collection server 100 is ten days and that the number of errors in the software A and the software C during the period of time of ten days is 10. Furthermore, it is indicated that the continuous operation time, that is, ten days, as the performance for the continuous operation time, is shorter than the performance threshold. Additionally, it is indicated that the number of times that the error occurs during the period of time of ten days, that is, 10, as the error occurrence frequency, is greater than the error frequency threshold. Then, it is indicated that the safety level in a case where both of the software A and the software C operate in the collection server 100 is evaluated as being “risky”.

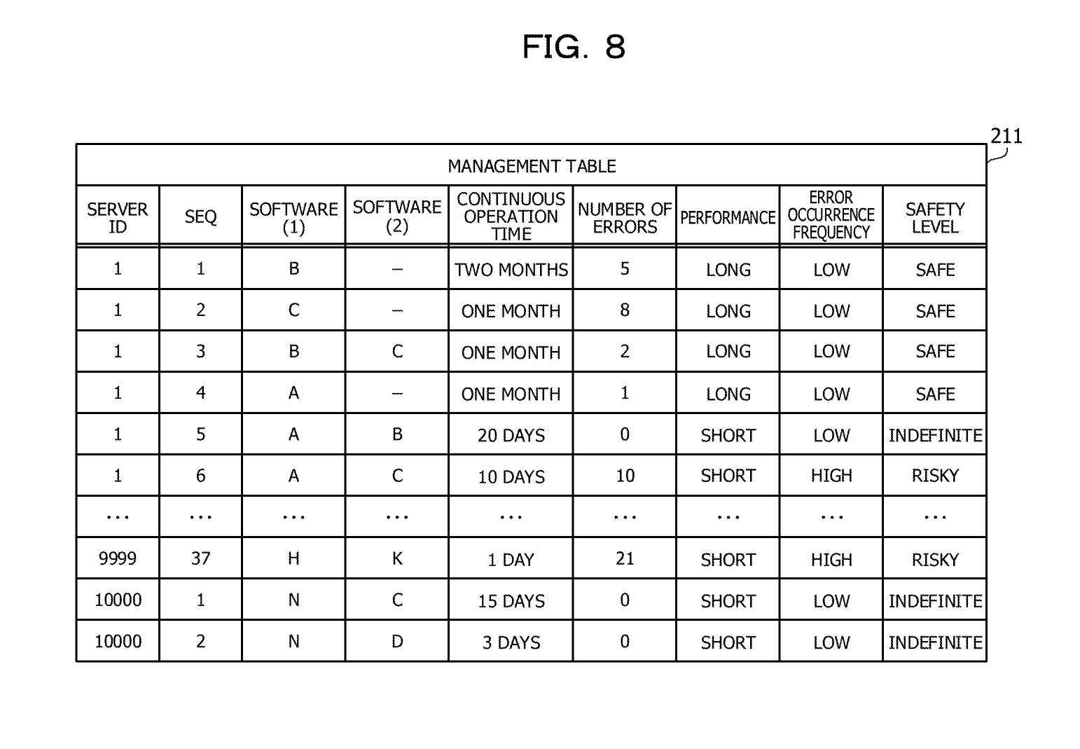

At this point, it may be considered that the continuous operation time, that is, one day, is equivalent to 24 hours. Furthermore, it may be considered that the continuous operation time, that is, one month, is equivalent to 24 hours×30 days=720 hours. FIG. 8 is a diagram illustrating an example of an entire server management table. A management table 211 is stored in the management information storage unit 210. The management table 211 is a table in which contents of the master management table, which are included in the information processing system and which are acquired from each server, are stored.

The management table 211 includes the following headings: the server ID, the SEQ, the software (1), the software (2), the continuous operation time, the number of errors, the performance, the error occurrence frequency, and the safety level. Information that is registered under each heading is the same as that registered under the same heading for the master management table 112. A record relating to a plurality of servers is registered in the management table 211. Which server has information that is each record is identified by the server ID.

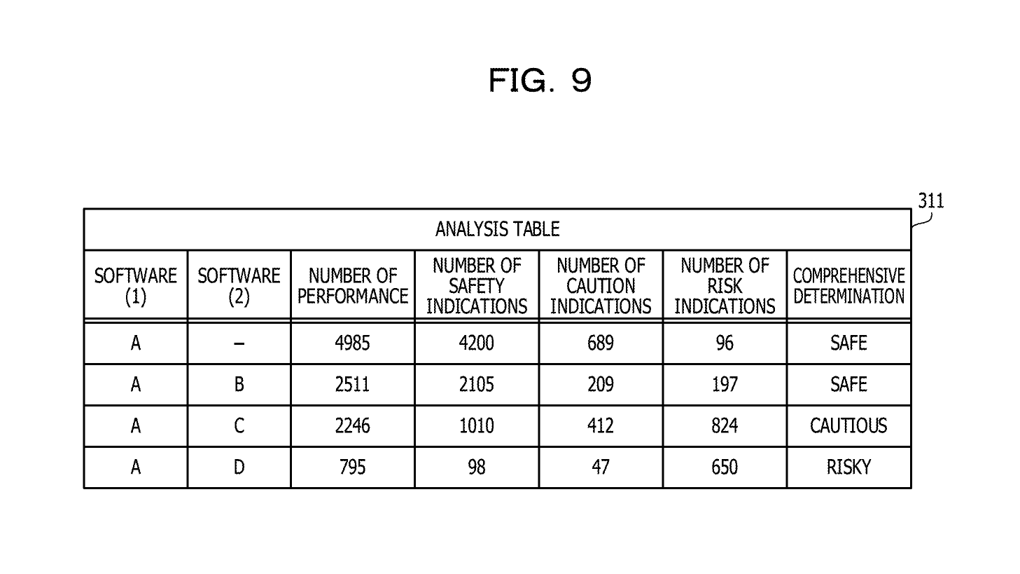

FIG. 9 is a diagram illustrating an example of an analysis table. The analysis table 311 is stored in the analysis information storage unit 310. The analysis table 311 illustrates a case where after the software B, the software C, and the software D have already been installed on the analysis server 300, new software A is installed on the analysis server 300. The analysis table 311 includes the following headings: the software (1), the software (2), the number of performances, the number of safety indications, the number of caution indications, the number of risk indications, and comprehensive determination.

The identification information on the first software is registered under the heading of the software (1). The identification information on the second software is registered under the heading of the software (2). The number of operational performance data of the software (or a set of pieces of software) in a different server is registered under the heading of the number of performances. Among operational performance data of the software (or the set of pieces of software) in the different, the number of performance data that have the safety level which is evaluated as being “safe” is registered under the heading of the number of safety indications. Among the operational performance data of the software (or the set of pieces of software) in the different, the number of performances that have the safety level which is evaluated as being “cautious” is registered under the heading of the number of caution indications. Among the operational performance data of the software (or the set of pieces of software) in the different, the number of performances that have the safety level which is evaluated as being “risky” is registered under the heading of the number of risk indications. A result of comprehensive determination of an index of the safety level when the software or the set of pieces of software is caused to operate is registered under the heading of the comprehensive determination. The result of the comprehensive determination is a result of determination based on a ratio of each of the number of safety indication, the number of caution indications, and the number of risk indications to the number of performances. As the results of the comprehensive determination, there are three types of categories: “safe”, “risky”, and “cautious”. The term “safe” indicates that the likelihood that the malfunction will occur is comparatively low. The term “risky” indicates that the likelihood that the malfunction will occur is comparatively high. The term “cautious” indicates that the likelihood that the malfunction will occur does not falls into any of the “safe” and “risky” categories, and thus there is a desire to exercise caution.

For example, in the analysis table 311, as pieces of information, “A”, “4985”, “4200”, “689”, “96”, and “safe” are registered under the headings of the software (1), the number of performances, the number of safety indications, the number of caution indications, the number of risk indications, and the comprehensive determination, respectively, and non-setting is provided for registration under the heading of the software (2).

This indicates that the number (the number of performances) of other servers into which the software A is installed is 4985. Furthermore, this indicates that among them, the number of other servers of which the safety level is “safe” is 4200, the number of other servers of which the safety level is “cautious” is 689, and the number of other servers of which the safety level is “risky” is 96. Furthermore, the result of the comprehensive determination of the index of the safety level, which is determined from the number of safety indications, the number of caution indications determination, and the number of risk indications, is “safe”. In this case, although the software A is installed on the analysis server 300 and is caused to operate, it is said that the likelihood that the malfunction will occur is comparatively low.

For example, in the analysis table 311, as pieces of information, “A”, “B”, “2511”, “2105”, “209”, “197”, and “safe” are registered under the headings of the software (1), the software (2), the number of performances, the number of safety indications, the number of caution indications, the number of risk indications, and the comprehensive determination, respectively.

This indicates that the number (the number of performances) of other servers into which both of the software A and the software B are installed is 2511. Furthermore, this indicates that among them, the number of other servers of which the safety level is “safe” is 2105, the number of other servers of which the safety level is “cautious” is 209, and the number of other servers of which the safety level is “risky” is 197. Furthermore, the result of the comprehensive determination of the index of the safety level, which is determined from the number of safety indications, the number of caution indications determination, and the number of risk indications, is “safe”. In this case, it is said that although the software A is installed on the analysis server 300, and the software A and the software B are caused to operate, the likelihood that the malfunction will occur is comparatively low.

Furthermore, for example, in the analysis table 311, as pieces of information, “A”, “C”, “2246”, “1010”, “412”, “824”, and “cautious” are registered under the headings of the software (1), the software (2), the number of performances, the number of safety indications, the number of caution indications, the number of risk indications, and the comprehensive determination, respectively.

This indicates that the number (the number of performances) of other servers into which both of the software A and the software C are installed is 2246. Furthermore, this indicates that among them, the number of other servers of which the safety level is “safe” is 1010, the number of other servers of which the safety level is “cautious” is 412, and the number of other servers of which the safety level is “risky” is 824. Furthermore, the result of the comprehensive determination of the index of the safety level, which is determined from the number of safety indications, the number of caution indications determination, and the number of risk indications, is “cautious”. In this case, it is said that when the software A is installed on the analysis server 300, and the software A and the software C is caused to operate, there is a desire to exercise caution about the likelihood that the malfunction will occur.

Furthermore, for example, in the analysis table 311, as pieces of information, “A”, “D”, “795”, “98”, “47”, “650”, and “risky” are registered under the headings of the software (1), the software (2), the number of performances, the number of safety indications, the number of caution indications, the number of risk indications, and the comprehensive determination, respectively.

This indicates that the number (the number of performances) of other servers into which both of the software A and the software D are installed is 795. Furthermore, this indicates that among them, the number of other servers of which the safety level is “safe” is 98, the number of other servers of which the safety level is “cautious” is 47, and the number of other servers of which the safety level is “risky” is 650. Furthermore, the result of the comprehensive determination of the index of the safety level, which is determined from the number of safety indications, the number of caution indications determination, and the number of risk indications, is “cautious”. In this case, it is said that when the software A is installed on the analysis server 300, and the software A and the software D are caused to operate, the likelihood that the malfunction will occur is comparatively high.

Next, a processing procedure in a second information processing system is described. A procedure for use in the collection server 100 will be described below, and the same procedure as that for use in the collection server 100 is also executed in other collection servers (the collection servers 100a and 100b, and the like).

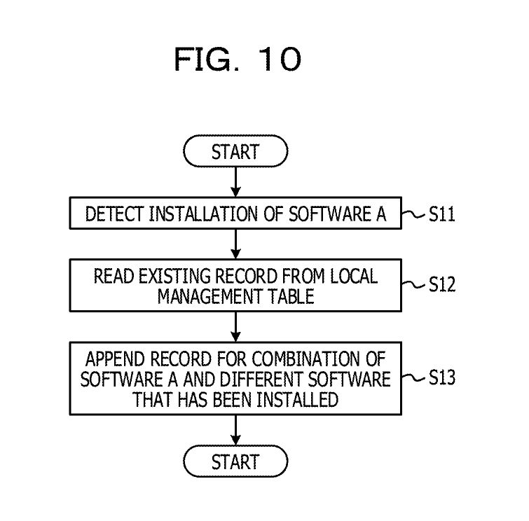

FIG. 10 is a flowchart illustrating an example of registering a management record at the time of the installation. Processing that is illustrated in FIG. 10 will be described below referring to step numbers. As an example, a case where the software A is installed on the collection server 100 will be described below. However, the same procedure also applies to a case where other pieces of software are installed.

The collection unit 120 detects installation of the software A on the collection server 100 (S11). Specifically, when the software A is installed on the collection server 100, the collection unit 120 detects that the software A is installed.

The collection unit 120 reads an existing record from the local management table 111 (S12). The existing record is a record relating to software (software other than the software A) that has already been installed on the collection server 100. That is, based on the local management table 111, the collection unit 120 can obtain the software (other than the software A) that has already been installed on the collection server 100.

The collection unit 120 appends a record relating to a combination of the software A that is newly installed, and the already-installed different software that is acquired in S12, to the local management table 111 (S13). The collection unit 120 also appends a record relating to the software A alone to the local management table 111.

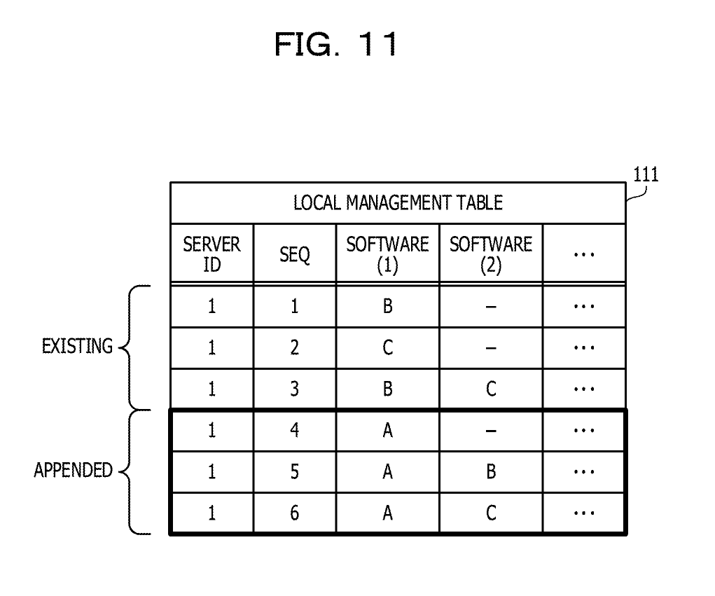

FIG. 11 is a diagram illustrating an example of appending a record for the local management table. For example, it is considered that in the local management table 111, in a case where records (records in which the SEQs are “1”, “2”, and “3”, respectively) relating to the software B and the software C are already present, the software A is installed on the collection server 100. In this case, the collection unit 120 appends the following three records to the local management table 111. The first record is a record (a record in which the SEQ is “4”) for the software A alone. The second record is a record (a record in which the SEQ is “5”) for a combination of the software A and the software B. The third record is a record (a record in which the SEQ is “6”) for a combination of the software A and the software C.

When the software A is installed on the collection server 100, it is possible for the software A operate in the collection server 100. The collection unit 120 manages the activation or the stopping of the software A according to the following procedure.

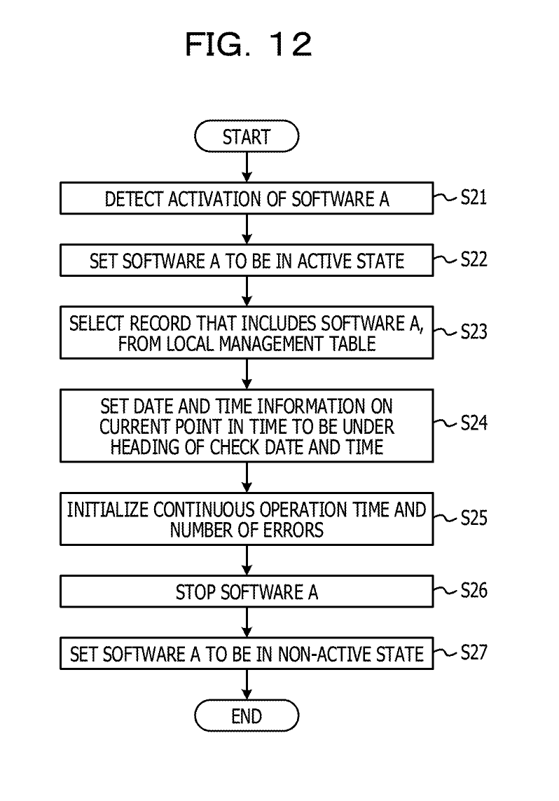

FIG. 12 is a diagram illustrating an example of processing at the time of the activation/stopping of the software. Processing that is illustrated in FIG. 12 will be described below referring to step numbers. The collection unit 120 detects the activation of the software A (S21).

The collection unit 120 sets the software A to be in an active (activation-completed) state (S22). For example, the collection unit 120 may change a flag (which, for example, is stored in a predetermined storage area of the RAM 102) corresponding to identification information on the software from a non-active (stopping-completed) state to the active state. In a case where the activation/stopping state can be managed by an OS of the collection server 100, the collection unit 120 may acquire the activation/stopping state of the software A from the OS.

The collection unit 120 selects a record that includes the activated software A, from the local management table 111 (S23). The collection unit 120 sets date and time information on a current point in time to be under the heading of the check date and time in the record that is selected in S23 (S24).

The collection unit 120 initializes the continuous operation time and the number of errors for the record that is selected in S23 (S25). Specifically, the collection unit 120 set the continuous operation time and the number of errors to 0 and 0, respectively.

The collection unit 120 detects the stopping of the software A (S26). The collection unit 120 sets the software A to be in the non-active state (S27). For example, the collection unit 120 may change the flag described above that corresponds to the identification information on the software A, for the active state from the non-active state.

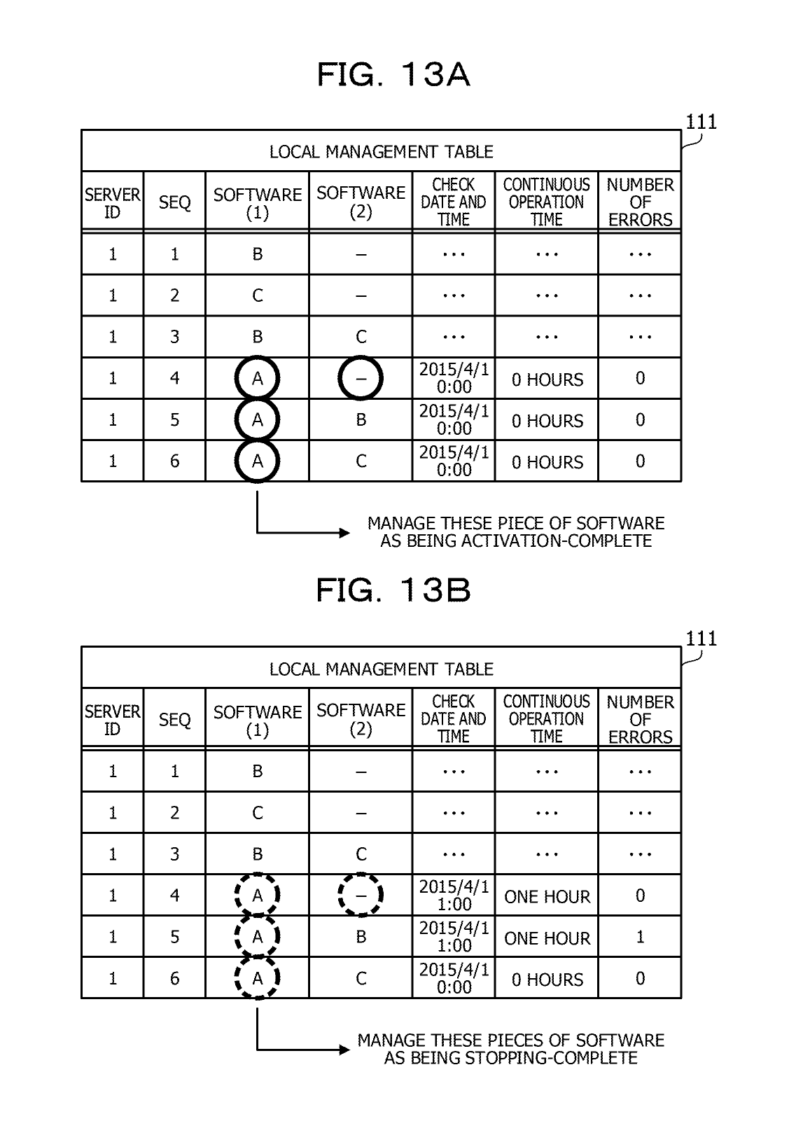

FIGS. 13A and 13B are diagrams, each illustrating an example of managing the activation/stopping of the software. FIG. 13A illustrates an example of managing the software A when the software A is activated. For example, when the software A is activated, the collection unit 120 sets a predetermined flag that corresponds to the software A, to be in the active state, and thus manages the software A as the software that has been activated. In this case, in the local management table 111, records (in which the SEQs are “3,” “4,” and “5”, respectively) “that corresponds to the software A are candidates for targets in which the continuous operation time or the number of errors is monitored.

FIG. 13B illustrates an example of managing the software A when the software A is stopped. For example, when the software A is stopped, the collection unit 120 sets a predetermined flag that corresponds to the software A, to be in the non-active state, and thus manages the software A as the software that has been stopped. In this case, in the local management table 111, the records (in which the SEQs are “3,” “4,” and “5”, respectively) “that corresponds to the software A are excluded from the candidates for targets in which the continuous operation time or the number of errors is monitored.

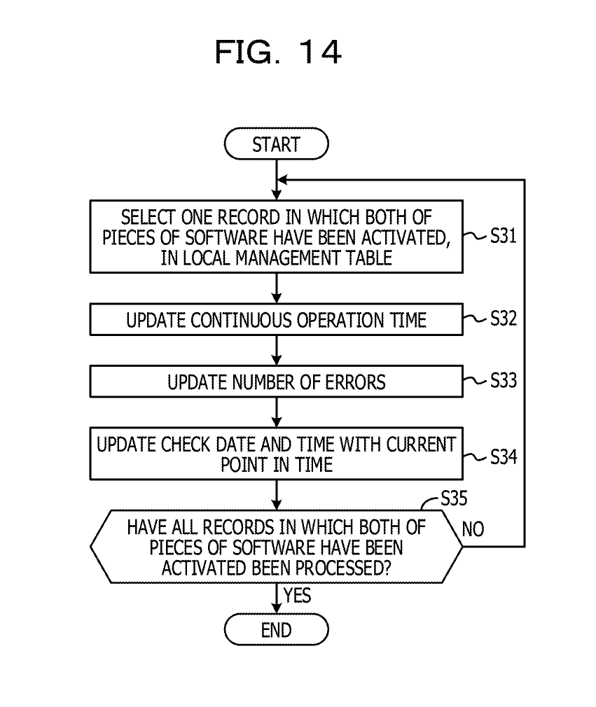

FIG. 14 is a flowchart illustrating an example of updating the continuous operation time and the number of errors. Processing that is illustrated in FIG. 14 will be described below referring to step numbers. The collection unit 120 executes the following procedure periodically (for example, one time per one hour or the like).

The collection unit 120 selects one record in which both pieces of software have been activated, in the local management table 111 (S31). Records that are selection targets also include records in which the identification information on software is set to be under the heading of the software (1), but non-setting is provided for registration under the software (2), among records that are included in the local management table 111.

The collection unit 120 updates the continuous operation time in the record that is selected in S31 (S32). Specifically, the collection unit 120 calculates a time difference between a check date and time (a point in time that results from updating the last-time continuous operation time) that is included in the record and a current point in time. The collection unit 120 adds the calculated time difference to the continuous operation time that is included in the record. The collection unit 120 set the time that results from the addition, to be under the heading of the continuous operation time in the record.

The collection unit 120 updates the number of errors (S33). For example, the collection unit 120 acquires the number of errors that occur in the software that corresponds to the record which is selected in S31, from the check date and time that is included in the record, to a current point in time. The collection unit 120 may acquire the number of errors, from each piece of software, and may acquire the number of errors from an OS log. The collection unit 120 may record an error that occurs in each piece of software in the RAM 102 each time the error occurs, in a state of being associated with a point in time at which the error occurs, and may acquire the number of errors in each piece of software from a result of the recording. Then, the collection unit 120 adds the number of errors that is acquired this time, to the number of errors (the number of errors that occurs until the last-time update point in time) that is included in the selected record, and thus updates the number of errors in the record that is selected in S31.

The collection unit 120 updates a check date and time in the record that is selected in S31, with a current point in time (S34). The collection unit 120 determines whether or not all records in which both of pieces of software have been activated have been processed (S35). In a case where all the records have been processed, the processing ends. In a case where all the records have not been processed, the processing proceeds to S31.

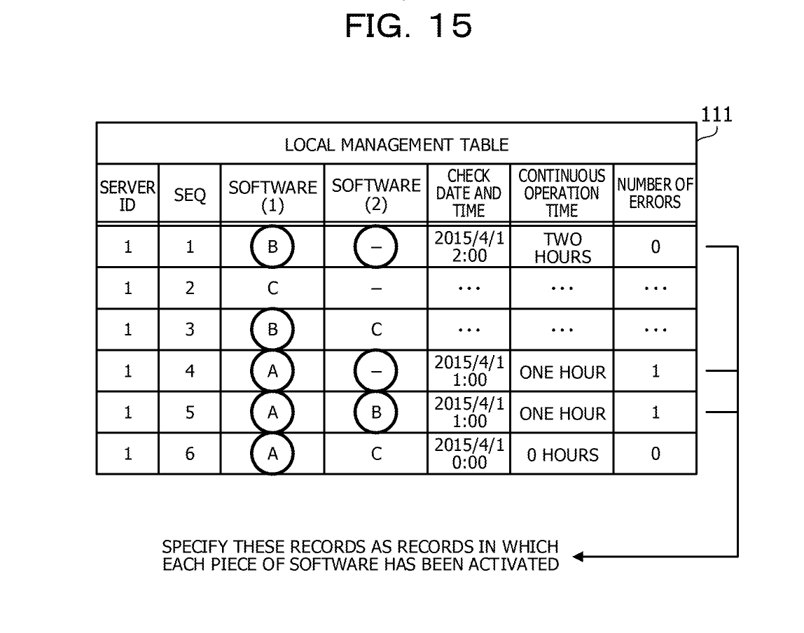

FIG. 15 is a diagram illustrating a specific example of a record in which each piece of software has been activated. As illustrated in FIGS. 12, 13A, and 13B, the collection unit 120, for example, manages an activation/stopping state of each of the software A, the software B, and the software C that are installed in the collection server 100. For example, it is assumed that the software A and the software B have been activated, and the software C has been stopped.

In this case, it is said that, among a plurality of records that are included in the local management table 111, records in which all pieces of software have been activated are records in which the SEQs are “1”, “4”, and “5”, respectively. Consequently, the collection unit 120 specifies the records in which the SEQs are “1”, “4”, and “5”, respectively, as records in which each piece of software has been activated.

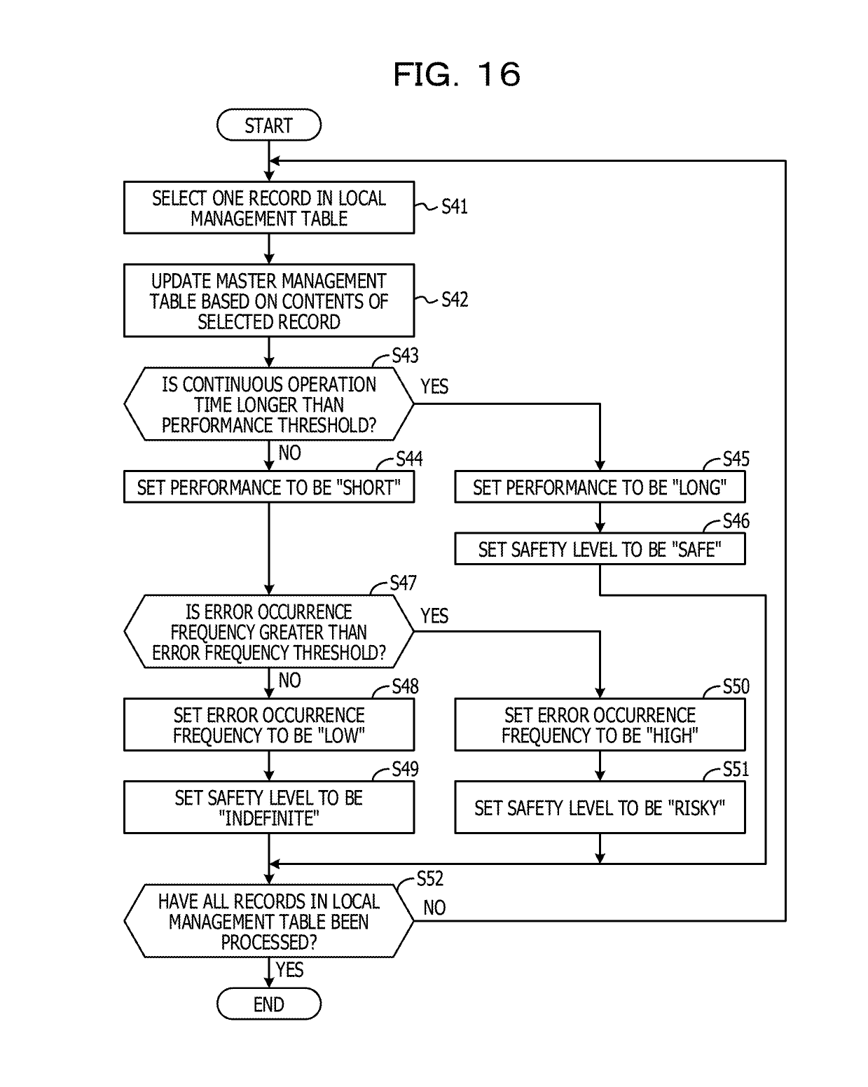

FIG. 16 is a flowchart illustrating an example of updating the master management table. Processing that is illustrated in FIG. 16 will be described below referring to step numbers. The collection unit 120 executes the following procedure periodically (for example, one time per one day or the like) (executes the following procedure with a longer periodicity than the periodicity with which the local management table 111 is updated).

The collection unit 120 selects one record from the local management table 111 (S41). The collection unit 120 updates the master management table 112 based on contents of the record that is selected in S41 (S42). Specifically, with the SEQ in the record (a record that is an update source) that is selected in S41, the collection unit 120 selects records (records that are consistent in the SEQ) that are update destinations, in the master management table 112. Then, the collection unit 120 sets the check date and time in the record that is the update source, to be in the record that is the update destination. Furthermore, the collection unit 120 reflects the continuous operation time in the record that is the update source, in the continuous operation time in the record that is the update destination (adds the continuous operation time from the last-time reflection point in time to this-time reflection point in time). Additionally, the collection unit 120 adds the number of errors in the field that is the update source, to the number of errors in the record that is the update destination. After the update processing, in the record that is the update source, the collection unit 120 sets the check date and time to be a current point in time, the continuous operation time to 0, and the number of errors to 0. In some cases, the record that is the update destination is not present in the master management table 112. In this case, the collection unit 120 adds a record that corresponds to the record that is the update source, to the master management table 112 (the check date and time, the continuous operation time, and the number of errors in the record that is the update source are registered in the added record).

The collection unit 120 determines whether or not the continuous operation time that is updated in S42 and that is included in the record which is the update destination, among records in the master management table 112, is longer than the performance threshold (S43). In a case where the continuous operation time described above is longer than the performance threshold, the processing proceeds to S45. In a case where the continuous operation time described above is not longer than the performance threshold, the processing proceeds to S44. The performance threshold is a value that is determined in advance according to an effective operation, such as 20 days or 30 days (one month).

The collection unit 120 sets the performance in the record that is the update destination, to be “short” (S44). Then, the processing proceeds to S47. The collection unit 120 sets the performance in the record that is the update destination, to be “long” (S45).

The collection unit 120 sets the performance in the record that is the update destination, to be “safe” (S46). Then, the processing proceeds to S52. The collection unit 120 determine whether or not the error occurrence frequency that is included in the record which is the update destination is greater than the error frequency threshold (S47). In a case where the error occurrence frequency described above is greater than the error frequency threshold, the processing proceeds to S50. In a case where the error occurrence frequency described above is not greater than the error frequency threshold, the processing proceeds to S48. The error frequency threshold, for example, is a value that is determined in advance according to the effective operation, such as one time or two times per 10 days (240 hours).

The collection unit 120 sets the error occurrence frequency in the record that is the update destination, to be “low” (S48). The collection unit 120 sets the safety level in the record that is the update destination, to be “indefinite” (S49). Then, the processing proceeds to S52.

The collection unit 120 sets the error occurrence frequency in the record that is the update destination, to be “high” (S50). The collection unit 120 sets the safety level in the record that is the update destination, to be “risky” (S51). Then, the processing proceeds to S52.

The collection unit 120 determines whether or not all the records in the local management table 111 have been processed (S52). In a case where all the records have been processed, the processing ends. In a case where all the records have not been processing, the processing proceeds to S41. In S41, in the local management table 111, non-processed records are sequentially selected and the procedure described above is repeated.

Moreover, in S46, the collection unit 120 may perform the setting of the error occurrence frequency in the record that is the update destination (for example, as in S47, “low,” “high,” and the like may be set to be under the heading of the error occurrence frequency according to a comparison with the error frequency value). Alternatively, in S46, regardless of the error occurrence frequency (only with the continuous operation time), the safety level is set to be “safe” and because of this, the error occurrence frequency may be set to be “low” (or in this case, it is also considered that the error occurrence frequency is set to be non-setting).

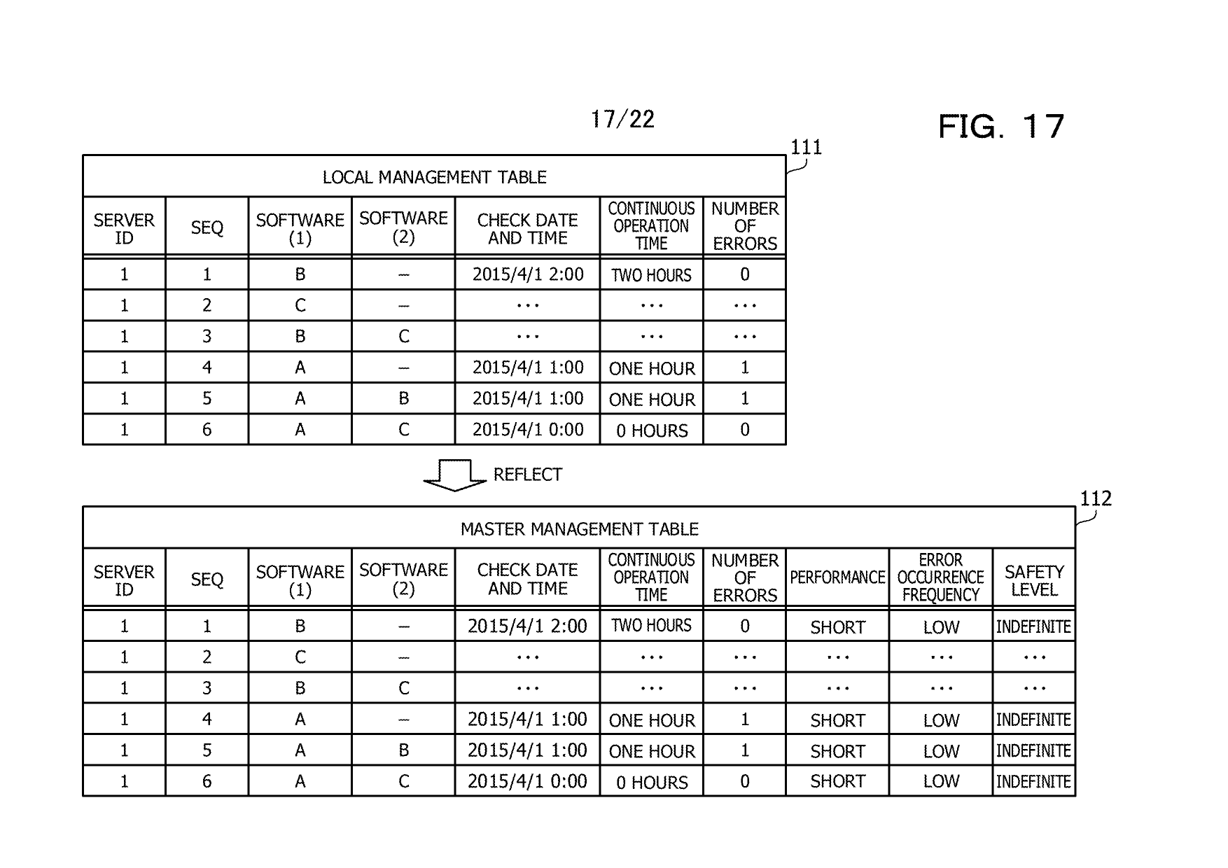

FIG. 17 is a diagram illustrating an example of updating the master management table. For example, a case where records in which the SEQs are “1” to “6”, respectively are registered in the local management table 111 is considered. The collection unit 120, for example, reflects contents of the local management table 111 in the master management table 112 with a predetermined periodicity such as one time per one day. Specifically, the collection unit 120 updates the continuous operation time or the number of errors that is registered in the master management table 112, based on the local management table 111. Then, the collection unit 120 registers results of evaluating the performance, the error occurrence frequency, and the safety level in the master management table 112, based on the post-update continuous operation time and the post-update number of errors.

At this time, if the continuous operation time is greater than a fixed length (the performance value), the collection unit 120 evaluates the safety level as being “safe”. Generally, this is because there is a tendency for a lot of errors to occur in the initial state of the software introduction, and because if a fixed time elapses after the introduction, there is a tendency for the software to operate stably. On the other hand, when the continuous operation time is equal to or less than the performance value, if the error occurrence frequency is comparatively high, the collection unit 120 evaluates the error occurrence frequency as being “risky”. Furthermore, if the error occurrence frequency is comparatively low, the collection unit 120 evaluates the error occurrence frequency as being “cautious”.

The reason why, in a case where the continuous operation time is comparatively is short and the error occurrence frequency is comparatively high, the evaluation is made as being “risky” is because when the software or the set of pieces of software is caused to operate in the collection server 100, there is a likelihood that a bad influence will be exerted on an existing environment. Furthermore, the reason why, in a case where the continuous operation time is comparatively is short and the error occurrence frequency is comparatively low, the evaluation is made as being “cautious” is because there are few performances available in evaluating the safety level when the software or the set of pieces of software is caused to operate in the collection server 100.

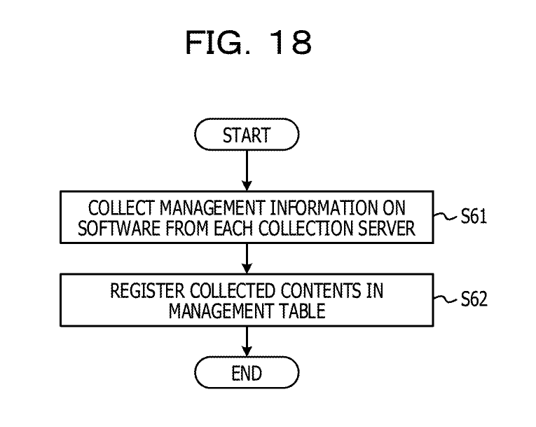

FIG. 18 is a flowchart illustrating an example in which the management server collects the management information. Processing that is illustrated in FIG. 18 will be described below referring to step numbers. The management unit 220 executes the following procedure periodically (for example, one time per one day) (the management unit 220, for example, executes the following procedure with a periodicity that is equal to or greater than an update periodicity of the master management table 112).

The management unit 220 collects management information on the software from each collection server (S61). For example, the management unit 220 acquires registration contents of the master management table 112 from the collection server 100. The management unit 220 acquires the registration contents of the master management table from each of the collection servers 100a and 100b as well.

The management unit 220 registers contents that are collected in S61, in the management table 211 (S62). By doing this, the contents that are registered in the management table 211 are synchronized to a master management table of each of the collection servers 100, 100a, and 100b. Furthermore, in the management table 211, a recent state of the master management table of each of the collection servers 100, 100a, and 100b is managed in a unified manner.

Moreover, in examples in FIGS. 16 to 18, it is assumed that the master management table is updated by each collection server based on the local management table, and the contents of the master management table is acquired by the management server 200 from each collection server. On the other hand, it is also considered that the management server 200 acquires the contents of the local management table from each collection server with a predetermined periodicity and the registration contents of the management table 211 are updated. That is, the management unit 220 may execute the procedure in FIG. 16.

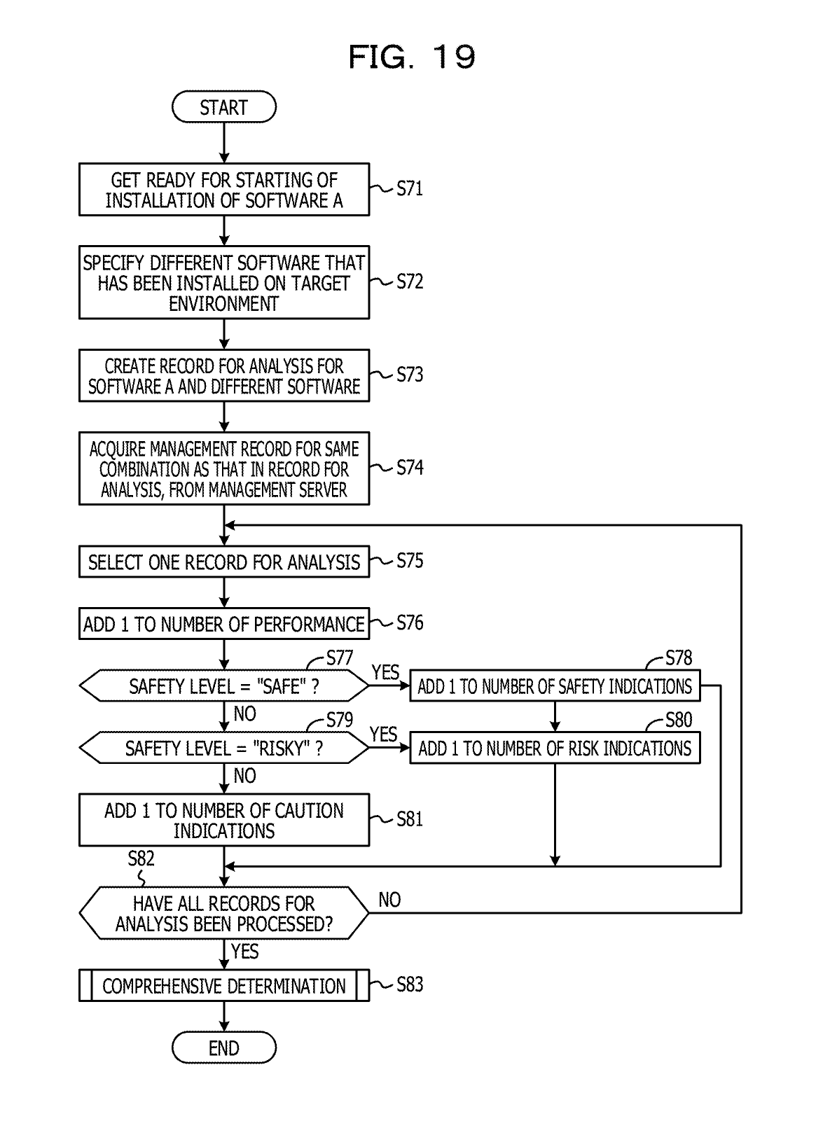

When new software is installed, the analysis server 300 acquires the contents of the management table 211 from the management server 200, and evaluates an influence on the existing software. FIG. 19 is a flowchart illustrating an example of an analysis at the time of the installation. Processing that is illustrated in FIG. 19 will be described below referring to step numbers. A case where the software A is installed on the analysis server 300 will be described below as an example, and the same procedure also applies to a case where different software is installed on the analysis server 300.

The determination unit 320 gets ready for starting of the installation of the software A on the analysis server 300 (S71). The determination unit 320 puts the installation of the software A in hold. The determination unit 320 specifies different software that has been installed, for a target environment (in the present example, the analysis server 300) (S72). For example, the determination unit 320 may ask an OS of the analysis server 300 for information on different software that has been installed on the analysis server 300. Furthermore, for example, the determination unit 320 may specify the different software that has been into the analysis server 300, based on the local management table or the master management table that has been created in the analysis server 300.

The determination unit 320 creates a record for analysis in accordance with a combination of the software A and the different software that is specified in S72, and appends the created record to the analysis table 311 (S73). The determination unit 320 set to “0” the number of performances, the number of safety indications, the number of caution identification, and the number of risk indications in each record for analysis that is appended. Furthermore, the determination unit 320 sets the comprehensive determination in each record for analysis to be non-setting.

The determination unit 320 acquires a management record (a record for the management table 211) for the same combination as a combination of pieces of software in the record for analysis, from the management server 200 (S74). The determination unit 320 selects one record for analysis from the analysis table 311 (S75).

The determination unit 320 adds 1 to the number of performances in the selected record for analysis (an on-focus record for analysis) (S76). The determination unit 320 determines whether or not a setting value of the safety level in the management record that is consistent with software or a set of pieces of software that is included in the on-focus record for analysis is “safe” (S77). In a case where the setting value is “safe”, the processing proceeds to S78. In a case where the setting value is not “safe”, the processing proceeds to S79.

The determination unit 320 adds 1 to the number of safety indications in the on-focus record for analysis (S78). Then, the processing proceeds to S82. The determination unit 320 determines whether or not a setting value of the safety level in the management record that is consistent with software or a set of pieces of software that is included in the on-focus record for analysis is “risky” (S79). In a case where the setting value is “risky”, the processing proceeds to S80. In a case where the setting value is not “risky”, the processing proceeds to S81.

The determination unit 320 adds 1 to the number of risk indications in the on-focus record for analysis (S80). Then, the processing proceeds to S82. The determination unit 320 adds 1 to the number of caution indications in the on-focus record for analysis (S81).

The determination unit 320 determines whether or not all the on-focus records for analysis have been processed (S82). In a case where all the records for analysis have been processed, the processing proceeds to S83. In a case where all the records for analysis have not been processed, the processing proceeds to S75.

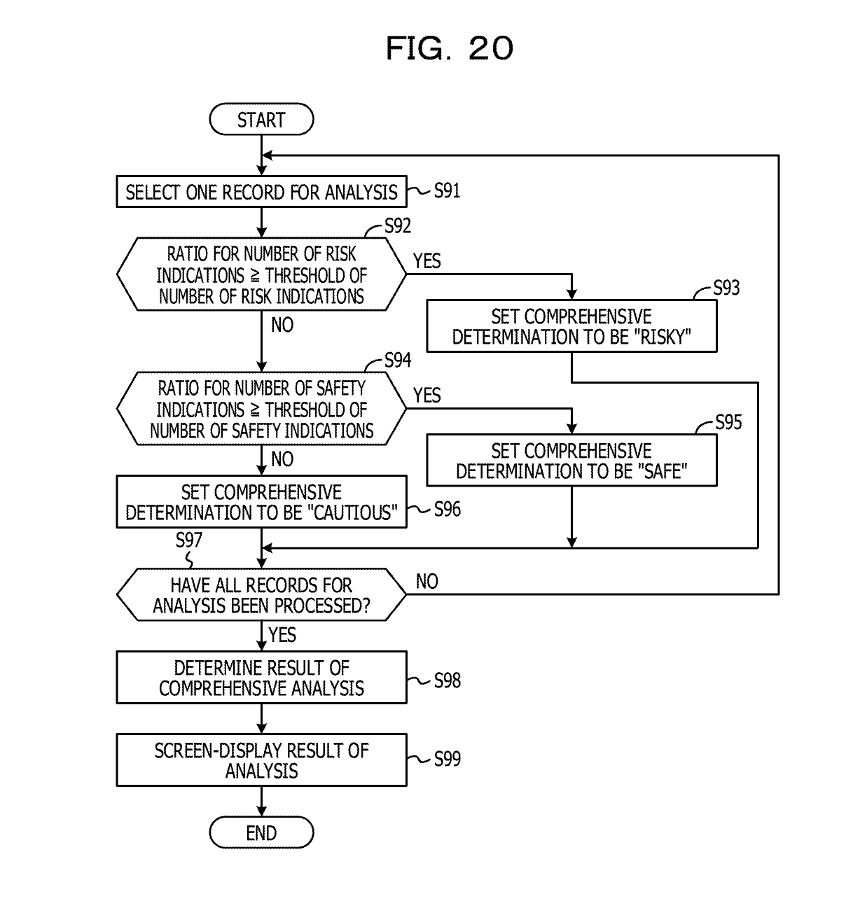

The determination unit 320 performs comprehensive determination of a result of the analysis relating to the installation of the software A based on the analysis table 311, and outputs the result of the comprehensive determination (S83). FIG. 20 is a flowchart illustrating an example of the comprehensive determination. Processing that is illustrated in FIG. 20 will be described below referring to step numbers. Moreover, a procedure that will be described below is equivalent to S83 in FIG. 19.

The determination unit 320 selects one record for analysis from the analysis table 311 (S91). The determination unit 320 determines whether or not a ratio of the number of risk indications to the number of performances that is included in the selected record for analysis (the on-focus record for analysis) is equal to or greater than a threshold of the number of risk indications (S92). In a case where the ratio of the number of risk indications to the number of performances is equal to or greater than the threshold of the number of risk indications, the processing proceeds to S93. In a case where the ratio of the number of risk indications to the number of performances is neither equal to nor greater than the threshold of the number of risk indications, the processing proceeds to S94. The threshold of the number of risk indications, for example, is determined in advance according to the effective operation, such as 80% or 90%. Specifically, it is considered that the higher the importance in business of the software that is executed by the analysis server 300, the smaller the threshold of the number of risk indications.

The determination unit 320 sets the comprehensive determination in the on-focus record for analysis, to be “risky” (S93). Then, the processing proceeds to S97. The determination unit 320 determines whether or not a ratio of the number of safety indications to the number of performances that is included in the on-focus record for analysis is equal to or greater than a threshold of the number of safety indications (S94). In a case where the ratio of the number of safety indications to the number of performances is equal to or greater than the threshold of the number of safety indications, the processing proceeds to S95. In a case where the ratio of the number of safety indications to the number of performances is nor equal to, nor greater than the threshold of the number of safety indications, the processing proceeds to S96. The threshold of the number of safety indications, for example, is determined in advance according to the effective operation, such as 80% or 90%. Specifically, it is considered that the higher the importance in business of the software that is executed by the analysis server 300, the greater the threshold of the number of safety indications.

The determination unit 320 sets the comprehensive determination in the on-focus record for analysis, to be “safe” (S95). Then, the processing proceeds to S97. The determination unit 320 sets the comprehensive determination in the on-focus record for analysis, to be “cautious” (S96).

The determination unit 320 determines whether or not all the records for analysis that are included in the analysis table 311 have been processed (S97). In a case where all the records for analysis have been processed, the processing proceeds to S98. In a case where all the records for analysis have not been processed, the processing proceeds to S91.

The determination unit 320 determines a result of the comprehensive analysis of the influence of the software A on the installation, based on the details of the comprehensive determination that are set to be in all the records for analysis which are included in the analysis table 311 (S98). Specifically, in a case where even one “riskiness” indication is included in the comprehensive determination in each record for analysis, the determination unit 320 determines the result of the comprehensive analysis as being “risky”. Furthermore, in a case where the “riskiness” indication is not included, and in a case where even one “caution” indication is included, the determination unit 320 determines the result of the comprehensive analysis as being “cautious”. Furthermore, in a case where the comprehensive determination in each of all the records for analysis is “safe”, the determination unit 320 determines the result of the comprehensive analysis as being “safe”.

The determination unit 320 screen-displays the result of the analysis (S99). The determination unit 320 outputs a result of the determination to a display device, such as a display, which is connected to the analysis server 300, and displays an image of the result of the analysis on the display device. Alternatively, the analysis server 300 may transmit the result of the analysis to a different server that is connected to the network 10, and may cause the result of the analysis to be displayed by the different server. The details that are displayed include details of the comprehensive determination, which are determined between the software A that is an installation target and different software that has been installed on the analysis server 300, and details of the result of the comprehensive analysis that is determined by each comprehensive determination.

The determination unit 320 may display an input unit in which whether or not to continue to the installation of the software A is input, on the display device, along with the image of the result of the analysis. When this is done, after checking the result of the analysis, the user can input into the analysis server 300 whether to continue or stop the installation of the software A on the analysis server 300. Furthermore, in a case where the result of the comprehensive analysis is “risky,” the determination unit 320 may forcibly stop the installation of the software A.

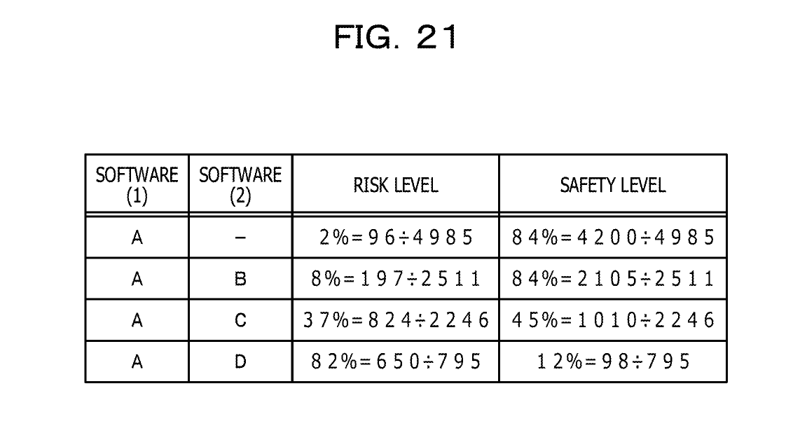

FIG. 21 is a diagram illustrating an example of calculating a risk level/safety level. In FIG. 21, the example of calculating the risk level/safety level that is based on the analysis table 311 is illustrated. Specifically, the risk level (the number of risk indications/the number of performances) that results when the software A is installed on the analysis server 300 and the software A alone is caused to operate is 2%=96/4985 (because the left side is expressed as a percentage, a description of “×100” by which the left side is multiplied is omitted). The safety level (the number of safety indications/the number of performances) is 84%=4200/4985.

The risk level that results when the software A is installed on the analysis server 300 and both of the software A and the software B are caused to operate is 8%=197/2511. The safety level is 84%=2105/2511.

The risk level that results when the software A is installed on the analysis server 300 and both of the software A and the software C are caused to operate is 37%=824/2246. The safety level is 45%=1010/2246.

The risk level that results when the software A is installed on the analysis server 300 and both of the software A and the software D are caused to operate is 82%=650/795. The safety level is 12%=98/795.

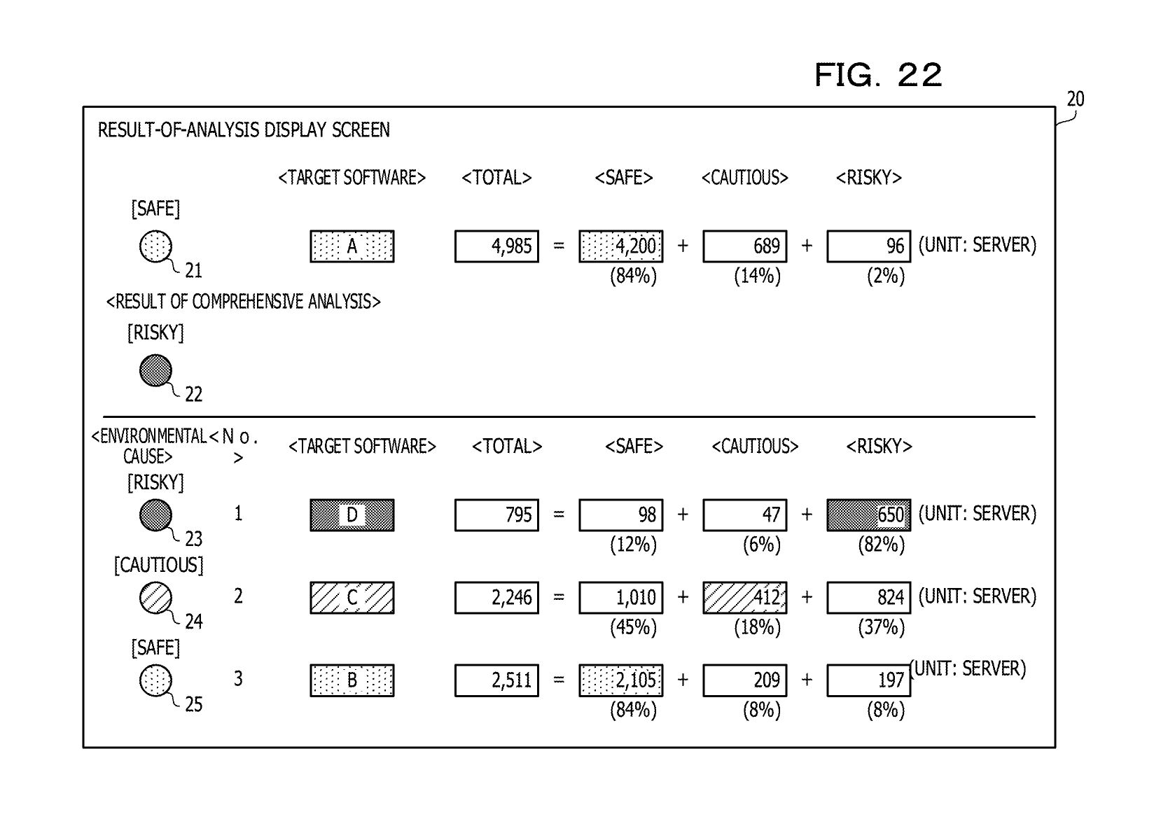

FIG. 22 is a diagram illustrating an example of a result-of-analysis display screen. For the installation-target software A and the software B, the software C, and the software D that have already been installed on the analysis server 300, the determination unit 320 generates information of a result-of-analysis display screen 20 that includes the result of the evaluation, and outputs the generated information to the display device. The result-of-analysis display screen 20 is displayed on the display device.

For example, the result-of-analysis display screen 20 includes the result of the evaluation that is obtained when the software A alone is caused to operate. With the analysis table 311, for the software A (an identification name is indicated in a “<target software>” box), the total number of performances is “4985”, “the number of safety indications is “4200”, the number of caution indication is “689”, and the number of risk indications is “96”. Therefore, “<all>”, “<safe>”, “<cautious>”, and “<risky>” values are indicated in “<all>”, “<safe>”, “<cautious>”, and “<risky>” boxes, respectively. Furthermore, a ratio of each value to the number of performances is indicated under the value in each box. Furthermore, the result-of-analysis display screen 20 includes an indication part 21 that is associated with the identification name of the software A, in a row for the software A.

The indication part 21 is an image that expresses in color the result of the comprehensive determination relating to the operation of the software A alone, which is determined based on the ratios of each of the number of safety indications, the number of caution indications, and the number of risk indications to the total number of performance. For the operation of the software A alone, the comprehensive determination is “safe”. The indication part 21 indicates “safe,” for example, in blue. Furthermore, a display place for the identification name of the software A and a display place (which, in an example of the indication part 21, is “4200” in the “<safe>” box) for a numerical value that serves as a basis on which it is determined that the comprehensive determination is “safe,” are also indicated in the same color as in the indication part 21 (this is also true for different software that is indicated below).

Furthermore, the result-of-analysis display screen 20 includes an indication part 22 that indicates the result of the comprehensive analysis in which an influence on the software B, the software C, and the software D that have been displayed, which will be described below, is also considered, in a “<result of comprehensive analysis>” box. In the present example, the result of the comprehensive determination that is determined from the result of the comprehensive determination for the software A, the set of the software A and the software B, the set of the software A and the software C, and the set of the software A and the software D is “risky”. The indication part 22 indicates “risky”, for example, in red.

Additionally, the result-of-analysis display screen 20 includes a result of the evaluation for the set of each of the software B, the software C, and the software D that have been installed on the analysis server 300, and the software A. For example, each result of the evaluation is displayed, from the upper portion of the screen to the lower portion of the screen in decreasing order of the risk level of the software of which the risk level is evaluated by the comprehensive determination as being high, on the result-of-analysis display screen 20.

In an example in FIG. 21, the result of the comprehensive determination that is obtained when both of the software A and the software B are caused to operate is “safe”. The result of the comprehensive determination that is obtained when both of the software A and the software C are caused to operate is “cautious”. The result of the comprehensive determination that is obtained when both of the software A and the software D are caused to operate is “risky”. Therefore, the results of the evaluation for the set of the software A and the software D, the set of the software A and the software C, and the set of the software A and the software B are displayed in this order from the top down.

The total number of performances, the number of safety indications, the number of caution indications, and the number of risk indications for each set are displayed in the same manner as for the software A. Furthermore, the ratios of each of the number of safety indications, the number of caution indications, and the number of risk indications to the total number of performances are displayed in the same manner as for the software A. Additionally, the result-of-analysis display screen 20 includes indication parts 23, 24, and 25.

The indication part 23 is an image that expresses the result of the comprehensive determination that is obtained in a case where both of the software A and the software D are caused to operate, as being “risky”. Like the indication part 22, the indication part 23 express “risky,” for example, in red. The indication part 24 is an image that expresses the result of the comprehensive determination that is obtained in a case where both of the software A and the software C are caused to operate, as being “cautious”. The indication unit 24 indicates “cautious,” for example, in yellow. The indication part 25 is an image that expresses the result of the comprehensive determination that is obtained in a case where both of the software A and the software B are caused to operate, as being “safe”. Like the indication part 21, the indication part 25 express “safe,” for example, in blue.

In the example described above, among the four results of the comprehensive determination for the software A, the set of the software A and the software B, the set of the software A and the software C, and the set of the software A and the software D, the result of the comprehensive determination for the set of the software A and the software D is “risky”. Consequently, the determination unit 320 determines the result of the comprehensive analysis as being “risk,” and sets a display color of the indication part 22 to be in red.

Moreover, in the example described above, it is assumed that indexes (the result of the comprehensive determination and the result of the comprehensive analysis) that are output by the determination unit 320 are expressed with colors of the indication parts 21, 22, 23, 24, and 25, but may be expressed using a different method. For example, it is considered that the indication parts 21, 22, 23, 24, and 25 are expressed by a letter, a string of letters, or a diagram denoting “safe,” “cautious,” “risky,” or the like, are expressed with a blinking periodicity in accordance with “safe,” “cautious,” or “risky”, and so forth. Additionally, the determination unit 320 may notify the user of the “risky,” the “cautious,” or the like by generating a warning sound from a speaker that is connected to the analysis server 300.

Furthermore, according to the second embodiment, the example in which the continuous operation time mainly for a combination of two pieces of software is acquired is described. The reason for this is because in a case where a plurality of pieces of software operate at the same time, and all or any one of the pieces of software does not operate normally, the main cause is the competition among the pieces of software for the shared resources (a port number, a shared file, and the like). That is, if a combination of two different pieces of software is managed, there is no competition for the shared resources. However, a continuous operation time for a combination of three or more pieces of software may be acquired. Even in a case where the continuous operation time for the three or more pieces of software is acquired, a record for each of the local management table 111, the master management table 112, the management table 211, and the analysis table 311 is registered for every combination. With the method that is described according to the second embodiment, the analysis server 300 performs the comprehensive determination of every combination of the three or more pieces of software, based on the tables.

In this manner, with the information processing system according to the second embodiment, the performance for the continuous operation time for every combination of two or more pieces of information of software is collected from the server in operation, and is used for determination of compatibility with existing software when new software is introduced into a certain server. By doing this, the support for avoiding the malfunction due to the software introduction can be provided.

At this point, as the example according to the second embodiment, the processing is described in which the analysis server 300 evaluates the influence of the installation when the software A is installed on the analysis server 300. In contrast, the analysis server 300 may evaluate the influence of the installation of the software on a different server when new software is installed on the different server (for example, the collection servers 100, 100a, and 100b and the like). In that case, the analysis server 300 receives input of an identification name of a server that is an installation destination and an identification name of installation-target software. When this is done, the analysis server 300 can acquire software that has been installed in the server which is the installation destination, from the management server 200, based on the identification name of the server that is the installation destination. For example, the management server 200 can receive an inquiry about the identification name of the server that is the installation destination and the like, from the analysis server 300, can search the management table 211 for the software that corresponds to the identification name of the server and that has been installed, and can provides the software that is found, to the analysis server 300. Then, the analysis server 300 acquires management records that correspond to the software that is the installation target and the software which has been installed on the server that is the installation destination, from the management server 200. When this is done, with a procedure according to the second embodiment, the analysis server 300 can evaluate an influence that results when the installation-target software is installed on the server that is the installation destination.

Furthermore, in some cases, in the collection servers 100, 100a, and 100b and the analysis server 300, operation environments (for example, pieces of hardware, OSs, or the like) for executing certain software are the same or different. In that case, the management server 200 may acquire information (for example, pieces of information on pieces of hardware, OSs, or the like) on the operation environment, from the collection servers 100, 100a, and 100b, and may retain the information on the operation environment in a state of being associated with the server ID. When this is done, for example, it is possible for the management server 200 to provide a management record in accordance with the operation environment of the software in the analysis server 300 to the analysis server 300.

Additionally, it is assumed that the management server 200 is provided separately from the collection servers 100, 100a, and 100b, and the analysis server 300, and that information relating to the operational performance of the software in each server is managed by the management table 211 in a unified manner, but the management server 200 may not be provided. For example, without providing the management server 200, any server, such as the analysis server 300, may collect the information relating to the operational performance of the software from each server, may retain the same information as in the management table 211, and may be in charge of the same function as that of the management server 200 (for example, the management unit 220 may be provided to the analysis server 300).

Moreover, information processing according to the first embodiment can be realized by causing the arithmetic operation unit 1b to execute a program. Furthermore, information processing according to the second embodiment can be realized by causing the processor 101 to execute the program. The program can be recorded in the computer-readable recording medium 13.

For example, the program can be circulated by distributing the recording media 13, on each of which the program is recorded. Furthermore, the program may be stored in a different computer and the program may be distributed over a network. The computer, for example, may store (install) the program recorded on the medium 13 or the program received from the different computer in the storage device such as the RAM 102 or the HDD 103 and may read and execute the program from the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A software introduction supporting method comprising:
collecting data that indicates operational performance of a plurality of pieces of software operated in a plurality of servers;
calculating a continuous operation time for which two or more pieces of software included in the plurality of pieces of software operate in parallel for each server, respectively, based on the collected data;
generating an index relating to an influence of introduction of first software to be introduced into one server, based on information that specifies second software introduced into the one server and on the continuous operation time for the two or more pieces of software that includes the first software, when one of the plurality of pieces of software is the first software; and
outputting the generated index.

2. The software introduction supporting method according to claim 1,
wherein the outputting includes:
determining the index based on the number of servers that are evaluated as operating stably, and the number of servers that are evaluated as not operating stably; and
outputting the determined index.

3. The software introduction supporting method according to claim 2,
wherein the outputting includes:
calculating a first ratio of the number of the servers that are evaluated as operating stably to the total number of the servers as targets that are evaluated for a stability in accordance with the continuous operation time, and a second ratio of the number of the servers that are evaluated as not operating stably to the total number; and
outputting the index indicating a likelihood that an error occurs when the two or more pieces of software are caused to operate, according to the first ratio and the second ratio.

4. The software introduction supporting method according to claim 2,
wherein the evaluating includes evaluating the stability that results when the two or more pieces of software operate, based on an error occurrence frequency relating to the two or more pieces of software for the continuous operation time, in a case where the continuous operation time is equal to or less than a threshold.

5. The software introduction supporting method according to claim 1,
wherein the outputting includes outputting the index for each combination of the first software and the second software.

6. The software introduction supporting method according to claim 1,
wherein the outputting includes outputting screen information including the index indicating a likelihood that an error occurs when the two or more pieces of software are operated.

7. A software introduction supporting apparatus comprising:
a memory configured to store data indicating operational performance of each of a plurality of pieces of software that operate in a plurality of servers; and
a processor configured to:
calculate a continuous operation time for which two or more pieces of software included in the plurality of pieces of software operate in parallel for each server, respectively, based on the collected data;
generate an index relating to an influence of introduction of first software to be introduced into one server, based on information that specifies second software introduced into the one server and on the continuous operation time for the two or more pieces of software that includes the first software, when one of the plurality of software is the first software; and
output the generated index.

8. The software introduction supporting apparatus according to claim 7,
wherein the processor:
determines the index based on the number of servers that are evaluated as operating stably, and the number of servers that are evaluated as not operating stably; and
outputs the determined index.

9. The software introduction supporting apparatus according to claim 7,
wherein the processor outputs the index for each combination of the first software and the second software.

10. The software introduction supporting apparatus according to claim 7,
wherein the processor outputs screen information including the index indicating a likelihood that an error occurs when the two or more pieces of software are operated.
